(19) United States
(12) Patent Application Publication
(10) Pub. No.: US 2019/0347335 A1
(43) Pub. Date: Nov. 14, 2019

(54) CATEGORIZATION OF WEBSITES

(71) Applicant: Apple Inc., Cupertino, CA (US)

(72) Inventors: Karl Christian Kohlschuetter, Monte Sereno, CA (US); John L. Blatz, San Francisco, CA (US); Danny H. Chau, Los Altos Hills, CA (US)

(73) Assignee: Apple Inc., Cupertino, CA (US)

(21) Appl. No.: 16/118,208

(22) Filed: Aug. 30, 2018

Related U.S. Application Data
(60) Provisional application No. 62/668,764, filed on May 8, 2018.
(60) Provisional application No. 62/679,860, filed on Jun. 3, 2018.

(51) Int. Cl. G06F 17/30

(52) U.S. Cl. CPC G06F 17/3089

(57) ABSTRACT

A probabilistic hash map can be used to store category information for large numbers of website in a relatively small amount of data. Retrieving the values can be performed with high accuracy and speed. The map consists of a set of buckets capable of storing data. Values are programmed into or retrieved from the map for each key by storing or retrieving the value(s) in association with an initial hash of the key within a subset of buckets of the map, the subset of buckets being selected based on additional hashes of the key. Value(s) can be stored inherently or via reference to a value index, which itself can embed values or further reference to larger payloads of value information.

### CROSS REFERENCE TO RELATED APPLICATIONS

This application claims priority to U.S. Provisional Patent Application No. 62/679,860 filed Jun. 3, 2018 and entitled “CATEGORIZATION OF WEBSITES,” and U.S. Provisional Application No. 62/668,764 filed May 8, 2018 and entitled “CATEGORIZATION OF WEBSITES,” the disclosures of which are hereby incorporated by reference in their entirety.

### TECHNICAL FIELD

The present disclosure relates to data categorization generally and more specifically to categorization of internet resources.

### BACKGROUND

Websites and other internet resources are routinely accessed through any number of devices, such as computers, smartphones, internet-of-things (IOT) devices, and other internet-accessible devices. It can be desirable to classify a website into various categories, such as based on topic. For example, some websites may be categorized as “shopping” or “retail” websites while others may be categorized as “educational” or “research” websites.

Categorization data for websites can be stored in large databases, where a given uniform resource locator (URL) can be supplied to the database and used to look up the corresponding category. Alternatively, all URLs associated with a particular category can be stored in a list, with category lookup requiring testing each URL of each list to see if it matches the given URL. These techniques suffer from large storage overhead and/or large memory usage necessary to provide results. To improve lookup times, these large databases can be stored remotely and remotely queried so that a dedicated high-performance servers can use computationally expensive techniques to determine a category and transmit a response.

Techniques have been attempted to improve categorization lookup by association each possible category with a separate Bloom filter programmed with those URLs that are associated with the respective category. A Bloom filter uses n hashed values of a given key to identify n different buckets, each of which contains a bit which can be set from a 0 to 1 when the key associated the that Bloom filter's category is programmed into the Bloom filter. Thus, a given URL can be tested against each category's Bloom filter to determine if it fits within that particular category. However, Bloom filters suffer from the possibility of false positives if a hashing collision ever occurs in which a given key that should not be part of the Bloom filter happens to match with buckets that are indeed set to 1. The probability of false positives can decrease by using additional hashing functions, however each additional hashing function used brings more complexity, storage requirements, and memory requirements to the data structure. Further, the need to store a separate Bloom filter for each category still requires testing a given URL against a Bloom filter for every possible category. As the number of categories, URLs, and hash functions all increase over time, the storage requirements and computational expense needed to use this approach increase dramatically.

### SUMMARY

A probabilistic hash map disclosed herein can be used to store value information retrievable per key for large numbers of key-value pairs, such as category information for websites, in a format that occupies reduced space and permits rapid querying with negligible false-positive probability. The probabilistic hash map can store a hash value from a key in association with information about the value associated with the key across one or more buckets that are selected based on additional hash values from the key. The probabilistic hash map can be easily expanded to include additional keys and/or values without substantially affecting the file size or query speed. The probabilistic hash map can advantageously provide a constant-time lookup, despite the number of keys and/or values stored in the data structure.

Despite the use of hashing functions instead of actual keys, the possibility of false positives in the disclosed probabilistic hash map can be negligible or nonexistent. A false positive would require collisions in multiple hash functions, as well as collisions in the mapping between the hash value stored in association with the value. The chance of such a collision can be negligible, and can be easily reduced by simply adding additional buckets to the set of available buckets, which would not change the query speed. Further, the probabilistic hash map can perform successfully for very large amounts of data with only one or two hash functions used to identify buckets into which information is placed.

The storage of hash values instead of original keys results in a reduced file size from the original key-value mapping, and results in faster query times. The structure of the probabilistic hash map also permits other optimizations, which can further reduce the file size and improve query speeds. For example, categories can be stored and/or referenced in a value index and be presorted by commonality, permitting reference to those categories to be made using relatively small index numbers. Further, key-value pairings can be efficiently stored in the probabilistic hash map by taking advantage of the relationships between hierarchically related keys (e.g., a specific webpage at a domain may share a category with the top page of that domain), the relationships between similar keys (e.g., URIs with differing protocols can share similar categories), or the relationships between a key and its associated value (e.g., some URLs can be categorized based on the domain name within the URL). Thus, instead of storing values for each key-value pairing, some of those key-value pairs can be efficiently encoded into the probabilistic hash map in a fashion that directs a particular key to query a different, or alternate version of the key, such as based on the above examples.

As a result, the probabilistic hash map disclosed herein can achieve numerous benefits, including reduced file storage costs, reduced computational expense (e.g., time and/or processing power), and improve privacy and security (e.g., ability to perform website categorization without sharing the queried website with third parties). The probabilistic hash map can achieve other benefits as well.

### BRIEF DESCRIPTION OF THE DRAWINGS

The specification makes reference to the following appended figures, in which use of like reference numerals in different figures is intended to illustrate like or analogous components.

FIG. 1 is a schematic diagram of a computing environment using data structures according to certain aspects of the present disclosure.

FIG. 2 is a schematic diagram of a data structure according to certain aspects of the present disclosure.

FIG. 3 is a schematic diagram depicting interactions with a data structure according to certain aspects of the present disclosure.

FIG. 4 is a flowchart depicting a process for querying a data structure according to certain aspects of the present disclosure.

FIG. 5 is a flowchart depicting a process for generating a data structure according to certain aspects of the present disclosure.

FIG. 6 is a flowchart depicting a process for populating the bucket data structure of a data structure according to certain aspects of the present disclosure.

FIG. 7 is a flowchart depicting a process for automatically extracting value information across a hierarchy of a uniform resource identifier according to certain aspects of the present disclosure.

FIG. 8 is a flowchart depicting a process for automatically obtaining multiple pieces of value information for a given key according to certain aspects of the present disclosure.

FIG. 9 is a flowchart depicting a process for using value information obtained from a data structure according to certain aspects of the present disclosure.

FIG. 10 is a block diagram of an example device, which may be a mobile device, using a data structure according to certain aspects of the present disclosure.

### DETAILED DESCRIPTION

Certain aspects and features of the present disclosure relate to a data structure used to store category information about numerous websites and other internet resources using a relatively small amount of storage space. The data structure can also permit the category information to be retrieved very rapidly. In some cases, the relatively small size of the data structure permits it to be stored entirely on the device that uses the data structure, thus permitting rapid categorization of numerous websites (e.g., millions of websites) entirely locally (e.g., without transmitting the website identifier away from the device for purposes of categorization).

Certain aspects and features of the present disclosure relate to encoding key-value associations into such a data structure, which can be later queried to retrieve any values for a given key. The data structure makes use of probabilistic techniques to encode key-value associations in an especially small amount of storage space and in a structure especially capable of being rapidly queried. While the data structure uses probabilistic techniques, embodiments can be capable of operating with no risk of collisions or a negligible risk of collisions (e.g., as compared to traditional probabilistic data structures). Encoding key-value associations into a data structure can include storing information associated with a key-value pairing such that the value is retrievable from the data structure by querying the data structure with a given key. According to certain aspects of the present disclosure, the data structure can be encoded with key-value associations without needing to store the key itself.

Traditional techniques for storing key-value pairs often have problematic downsides, such as time-complexity that scales linearly with the number of possible values (e.g., the lookup time to test a key with each category scales linearly as additional possible categories are added), space-complexity that scales linearly with the number of possible values (e.g., the size of the data structure scales linearly as additional possible categories are added), and the need to dramatically increase storage usage to keep collision errors at acceptable levels (e.g., low false-positive probabilities in traditional Bloom filters are achieved by drastically increasing the number of hashes performed and buckets used per key). In some cases, traditional techniques for storing key-value pair information require the actual keys to be stored within the data structure, which requires substantially large amounts of storage space and also exposes the underlying information (e.g., keys and key-value pairings) to unauthorized viewing. In some cases, storage space can be reduced by compressing a data structure, but compressed data structures can suffer from slow query speeds and increased memory usage due to the need for decompression.

By contrast, embodiments of the data structure disclosed herein can avoid these various downsides by combining techniques that keep storage space low while permitting rapid queries. In an example, a traditional Bloom filter may require approximately 5 megabytes of space to store a particular set of values and keys (e.g., approximately 58 values for approximately 74167 keys, with a false-positive probability value of 0.01), whereas an example of the present disclosure can store the same data in approximately 0.25 megabytes without any possibility of a false positive or with a negligible false-positive probability.

The benefits of the data structure disclosed herein can be leveraged across various fields in various ways. The categorization of internet resources is especially well-suited for leveraging the benefits of the data structure disclosed herein, as the relatively small data structure can be stored locally on the same device that is attempting to access the internet resource to be categorized, and because the data structure can be queried rapidly (e.g., in real time or with little to no discernable delay), thus permitting categorization to occur before or simultaneous to accessing the internet resource. For example, the data structure disclosed herein can store category information for millions of websites (e.g., millions of websites, tens of millions of websites, or more) in just a few megabytes of storage space. By contrast, existing techniques for storing category information for this many websites may occupy hundreds of megabytes of storage space, which is orders of magnitude more than the techniques disclosed herein. While described herein with regard to providing category information for internet resources, certain aspects and features of the present disclosure can be used to provide other values for other keys, as appropriate.

The data structure disclosed herein can be used in any suitable environment and can be used to store value information for numerous keys. Any computing device accessing the data structure can query the data structure to obtain value information (e.g., one or more values) associated with a given key. In some cases, instructions for how to query the data structure can be stored within the data structure itself, or can be separately known by the device accessing the data structure. Generally, the data structure can be accessed by the device upon which it is stored, however that need not always be the case. Generally, a data structure as disclosed herein can be generated at a central location and distributed to other devices, although that need not always be the case.

The small size of the data structure permits it to be stored in numerous devices without substantially impacting the amount of available space remaining on the device. Thus, even devices with relatively small amounts of storage can benefit from the data structure disclosed herein. Further, the small size of the data structure permits it to be easily deployed without using up substantial bandwidth. For example, millions of key-value pairs can be stored in a data structure and stored on a computing device, such as a smartphone. Whenever updates to the data structure occur, because of its small size, the entire data structure can be re-created with the updated information and sent to the smartphone as part of a firmware update. If other techniques for storing the key-value pairings were used, such as a 1:1 table, it may be impracticable to include a new table with each firmware update, as it would drastically increase the size of each firmware update, resulting in long download and/or update times. Additionally, the data structure as disclosed herein can be safely deployed in various fashions, such as transmitted over the internet, since the use of numerous hashes help obscure potentially trade secret information, such as a secret list of key-value mappings.

A. Internet Resource Category Retrieval

The techniques described herein are described with reference to accessing internet resources, which can include any resource accessible through an internet connection, such as websites, file transfer protocol (FTP) sites, app-enabled internet-accessible services (e.g., internet-based functions within native applications), and the like. Internet resources are generally accessed using a uniform resource identifier (URI). In some cases, a URI can provide protocol information for accessing the resource, in which case the URI can be a uniform resource locator (URL). For example, a user may access an internet resource that is a website via a native web browsing application according to the hypertext transfer protocol (HTML) using a URL, such as “http://www.apple.com.”

It can be desirable to quickly retrieve category information related to a website or other internet resource for numerous reasons. In an example, category information can be displayed to a user to provide information about the type of website being accessed. In another example, category information can be stored for each access attempt of an internet resource and used to provide compliance logs, generate usage data, or provide other analytics tracking usage of various categories of internet resources. Category information can be obtained in realtime. Category information can be obtained and/or leveraged before the internet resource is accessed (e.g., before requesting and/or receiving data from the internet resource), before the internet resource is loaded (e.g., before rendering or running any code from the internet resource), simultaneous with accessing or loading the internet resource, or after the internet resource is accessed or loaded.

In one example, category information can be stored and/or otherwise used to provide a user with information about how much time, bandwidth, or other resources are used with various categories of internet resources. This information can also be used to provide limits or quotas to these internet resources. For example, a parent wishing to curb time a child spends on social media websites may be able to set a maximum amount of time permitted on social media websites each day, after which further connections will be limited or denied. To achieve this result, the internet resources accessed by the child's device may need to be categorized, so that the correct internet resources (e.g., those identified as social media websites) are limited, such as described herein. It can be especially advantageous to achieve rapid categorization of internet resources without sending any personally identifiable data outside of the device for the purpose of categorization. In the case of a child's usage data, it can be especially desirable to provide this categorization without transferring the usage data off the child's device for purposes of categorization to ensure compliance with privacy and child protection because the usage data is collected from a child.

In another example, category information relating to a safety level of a website can be obtained and acted upon to control access to the website. This information can be obtained and/or acted upon before the request for data from the website is transmitted, before the data requested from the website is received, before the data from the website is rendered and/or any code is executed, simultaneously with accessing and/or loading the website, or after accessing and/or loading the website. In an example, when attempting to access a known nefarious website, category information indicative of a dangerous safety level can be obtained rapidly from an entirely local query and the system or application attempting to access the website can provide a warning, can entirely block the website, or can perform other actions (e.g., attempt further scrutiny or analysis of the website) prior to loading the website. In another example, when attempting to access a known safe website, category information indicative of a relaxed safety level can be obtained rapidly from an entirely local query and the system or application attempting to access the website can permit relaxed-security features, such as enabling autocompletion of fields on the website or enabling the execution of various scripts or code from the website.

In some cases, rapid, local categorization according to certain aspects of the present disclosure can enable features relying on categorization that may otherwise be technically impossible or impracticable because of the complexities and time involved in querying external servers or the storage space and computational limitations of previous value-key matching techniques.

In some cases, rapid, local categorization according to certain aspects of the present disclosure can enable features relying on categorization that may otherwise be legally impossible or impracticable because of laws regarding privacy, data governance, and the like.

Category information can include information related to an assignable category or topic of a resource. For example, category information can include a label for a website as being “social media,” “educational,” “news,” or any other suitable label. In some cases, category information can include information about the source of the website, such as a category for “Apple” websites associated with Apple Inc. In some cases, category information can include information related to a safety level associated with the website. For example, a known nefarious website may be associated with a category that is associated with an elevated safety level, whereas a known safe website may be associated with a category that is associated with a lowered safety level. In some cases, category information can include information related to the general topic of a website.

B. Example Environment

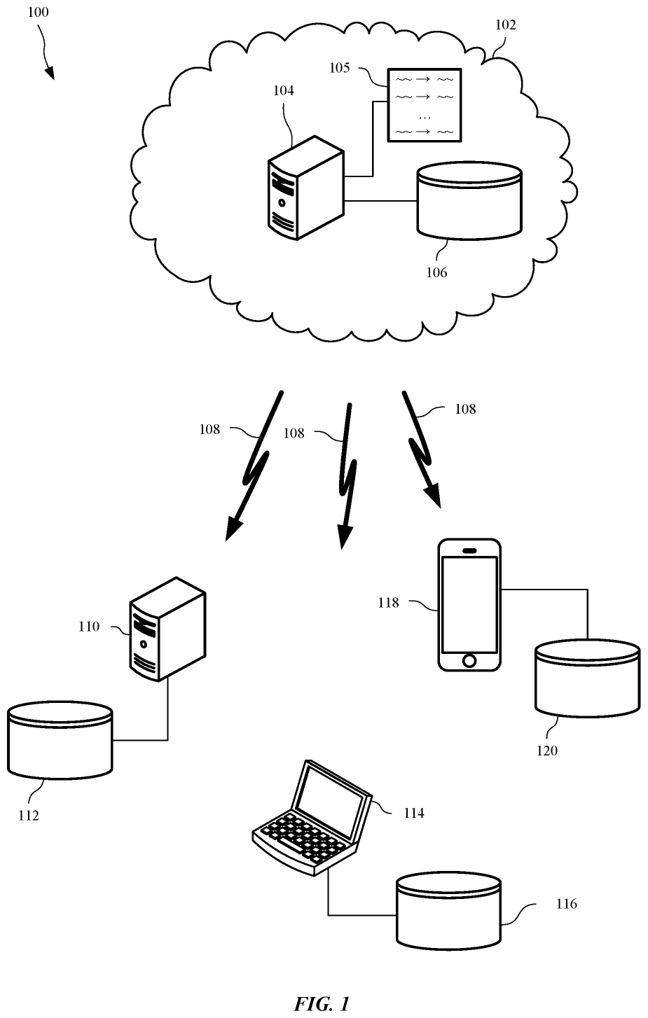

FIG. 1 is a schematic diagram of a computing environment 100 using data structures 106, 112, 116, 120 according to certain aspects of the present disclosure. The computing environment 100 can include any number of devices networked in any suitable fashion. As depicted in FIG. 1, the computing environment 100 includes a computer 110, a laptop 114, and a smartphone 118. The computing environment 100 also includes a server 104 capable of communicating with the computer 110, laptop 114, and smartphone 118 via communication paths 108. Communication paths 108 may be one way or two way paths, but are shown as one-way paths for illustrative purposes in FIG. 1. The server 104 can be accessible via a cloud 102, such as via the internet. The server 104 is depicted as a single device, however the server 104 can be implemented as one or more computing devices.

The server 104 can generate data structure 106 as described in further detail herein. Data structure 106 can be generated based on a mapping 105 of key-value pairs. The key-value pairs can be internet resources (e.g., websites) and categories. After generation, the data structure 106 can be distributed to the devices (e.g., computer 110, laptop 114, and smartphone 118), such as via communication paths 108. Distribution can occur in a pre-consumer fashion (e.g., built into the device when the device is first created) or post-consumer fashion (e.g., provided as an update to an existing device. Distribution can occur in hardware (e.g., provided as a physical piece of media, such as a flash drive) or software (e.g., provided as a downloadable firmware update). The data structure 106 can be encrypted and/or compressed during distribution. In some cases, the data structure 106 can be decrypted and/or decompressed when stored on the receiving device.

Each of the devices, including the computer 110, laptop 114, and smartphone 118, can have its own copy of the data structure (e.g., data structures 112, 116, 120, respectively). Thus, when smartphone 118 attempts to obtain category information for a given website, smartphone 118 can access data structure 120 and obtain the category information without transmitting the key (e.g., website) to any other system, such as without needing to transmit the key to a server on the internet. Likewise, smartphone 118 can obtain the category information without needing to receiving the category information through a network connection and/or an internet connection.

In some cases, a data structure 112 stored on one device (e.g., computer 110) can be accessible from another device (e.g., laptop 114), such as via a local network. In some cases, data structure 112 on computer 110 would only be accessible to laptop 114 if both the computer 110 and laptop 114 shared a common user account or a permitted user account (e.g., family sharing account). In such cases, laptop 114 may not have data structure 116 and may be able to perform query lookups using data structure 112 without transmitting query information or receiving category information outside of the local network or trusted network. In some cases, the data structure 116 of laptop 114 may be outdated and may be updated and/or replaced using another device's data structure, such as data structure 112 of computer 110.

As depicted in computing environment 100, the devices (e.g., computer 110, laptop 114, and smartphone 118) are able to store the information from the mapping 105 of key-value pairs within their respective data structures 112, 116, 120 using substantially reduced storage space. Further, the devices (e.g., computer 110, laptop 114, and smartphone 118) are able to obtain category information for websites by querying their respective data structures 112, 116, 120 that are local to the device, all without transmitting query information and/or receiving category information outside of the respective device.

### II. Probabilistic Hash Map

A. Organization of Data Structure

Certain aspects and features of the present disclosure relate to a data structure (e.g., probabilistic hash map) and techniques for interacting with the data structure, such as adding data to the data structure and querying the data structure (e.g., retrieving data from the data structure). The data structure can be stored in contiguous or non-contiguous memory. Various components are described herein with reference to the data structure, such as buckets and payloads, however these components need not be separated from one another as long as certain components are individually accessible, as necessary. As used herein, the terms “bucket” and “payload” are used for illustrative purposes, can include any suitable collection of data appropriate for the environment in which the data structure is used, and are not meant to infer any specification or limitations beyond those disclosed herein. For example, the terms “bucket” and “payload” can describe arbitrary locations within a data storage system without inferring any particular metadata, header information, or the like to those locations.

The data structure can be a probabilistic hash map capable of mapping a given key (e.g., a URI) to one or more values (e.g., categories). A given key is hashed to generate a primary hash result. A hash result can be a piece of data that results from processing a key using a hashing algorithm. In some cases, a hash result can be in the form of an integer, such as a 4-byte integer, although other forms can be used. The primary hash result is later used as an identifier associated with the key. The primary hash result will be stored in association with value data, which is usable to obtain the value (e.g., category) associated with the given key. In some cases, the value data can be the value itself. In other cases, the value data can be an index location on a value index. In such cases, the data stored at that index location of the value index can be the value itself, or can be a pointer (e.g., an address) where the value can be retrieved.

The primary hash result is stored in association with the value data within a probabilistic set. The probabilistic set can include a set of buckets containing one or more buckets, two or more buckets, three or more buckets, or any suitable number of buckets. Generally, the number of buckets can be calculated based on the number of key-value pairs (e.g., number of entries) and the target number of desired entries per bucket or per secondary hash result. For example, given 70 key-value entries and a target number of 5 entries per secondary hash result, the set of buckets can include 14 buckets

$$( \frac{70}{5} = 14 ) .$$

In some cases, it can be advantageous to round up the number of buckets to the next odd number and/or the next prime number. This rounding can improve the performance of the probabilistic set. Therefore, in the previous example, performance of the probabilistic set can be improved by using 15 buckets, or further improved by using 17 buckets.

The primary hash result and value data for a given key will be stored in one or more buckets based on a set of secondary hash results. One or more secondary hashes can be performed on the key to obtain one or more secondary hash results, each of which can be used to identify a bucket from the set of buckets. To identify a bucket, a modulo operation is performed, using the secondary hash result as the dividend and the number of buckets in the set of buckets as the divisor, resulting in the identification of one of the buckets. The primary hash result and value data for the given key are then stored in the identified bucket. In some cases, the set of secondary hashes can include two or more secondary hashes. In such cases, the primary hash result and value data is stored in two or more buckets, depending on the number of secondary hashes used. For example, if the set of secondary hashes includes two hashes, resulting in the identification of two buckets, the primary hash result and value data can be stored in the two identified buckets. The secondary hashes can be different from the primary hashes and different from one another, such as through use of different hashing algorithms.

Within a bucket, the primary hash result can be stored in association with value data using any suitable technique. In some cases, a bucket can contain one or more payloads, each payload containing value data and any number of primary hash results for keys associated with that particular value data. For example, multiple websites may be associated with an “entertainment” category and thus the primary hash results for each of those websites may be stored within a payload for the value data associated with the “entertainment” category. In some cases, the value data for a particular payload may in fact be associated with multiple values. For example, multiple websites may be associated with both a “technology” category and a “news” category, in which case the primary hash results for these websites may be stored within a payload for a particular value data that is associated with both the “technology” category and the “news” category.

In some cases, value data can be the value associated with the key. However, in some cases, value data can be an pointer or index directed to where the value information can be retrieved. For example, value data can be stored as an integer (e.g., a variable length integer) indicative of the location of the value information on a value index.

In some cases, the payload can be stored as a block of data starting with the value index. In some cases, the value index can be bit shifted to provide room for one or more bits of payload metadata that can serve as a count of the number of primary hash results that follow. For example, a value index bit shifted to the left by three bits can provide sufficient room to encode payload metadata in the form of a number from 0 to 7. If the payload metadata is non-zero, it can indicate the number of primary hash results that follow. Each primary hash result can be stored in a known format having a known length, such as an integer (e.g., a 4-byte integer), thus knowledge of the number of primary hash results permits each primary hash result to be accessed individually and informs the end of the payload without needing any sort of stop indicator. If the payload metadata is zero, it can indicate that the next piece of information is indicative of the number of primary hash results that follow. For example, if the payload metadata is zero, the following data can be in the form of a variable length integer capable of encoding any integer value, including any number from 8 upwards. The primary hash results can immediately follow the variable length integer. In an example, the payload metadata can be zero and can be followed by a variable length integer indicating a number of 9, in which case it is known that following the variable length integer are nine primary hash results. Other encoding schemes can be used.

In some cases, a bucket can contain multiple payloads. In some cases, storage savings can be achieved by storing the value data for subsequent payloads in the form of an delta offset from the previous payload's value data, with the first payload storing the actual value data as the value data. In an example, if three payloads were used in a bucket to encode value data of 123, 456, and 512, the value data can be stored in the first payload as “123,” the value data of the payload can be stored as “333,” and the value data of the third payload can be stored as “56.” By storing delta offsets instead of full value data, smaller variable length integers can be used.

In some cases, value data can indicate locations in a value index where further value information can be obtained. For example, a value index can contain indexed categories. In another example, a value index can contain indexed addresses that identify locations in a further segment of value payload data containing the desired value information. As used herein, the term “value information” can include a value or set of values associated with a given key. In some cases, as appropriate, the term “value information” can include data associated with a value, such as data usable to identify or obtain a value.

In some cases, the value payload data can be stored in order of the value index, such that two subsequent index values in the value index refer to two subsequent addresses in the value payload data. In such cases, the extent (e.g., start and end) of the value information for a given index value in the value index can be obtained by reading the address associated with the given index value and the address associated with the subsequent index value, which can be used to determine the end of the value information in the value payload data.

In some cases, no value payload data is present, with all values stored in the value index. In some cases, no value payload data or value index is present, with all values stored in the value data of the set of buckets. In some cases, the use of at least a value index can help reduce storage requirements by permitting the value data entries in the payloads of the buckets to remain as small as possible. Since multiple payloads may exist for a given key-value entry, it can be advantageous to minimize the size of the payloads. In some cases, an analysis can be performed during data structure generation that can inform whether or not to use a value index and/or value payload data.

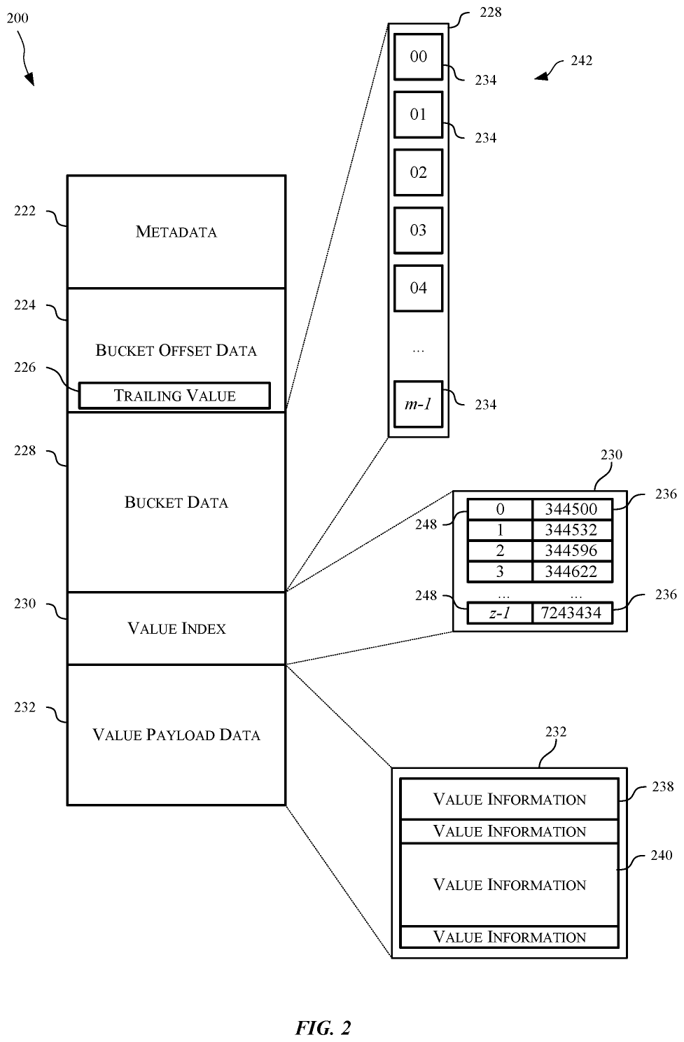

FIG. 2 is a schematic diagram of a data structure 200 according to certain aspects of the present disclosure. Data structure 200 can be data structures 106, 112, 116, 120 of FIG. 1. The data structure 200 can comprise multiple components, such as metadata 222, bucket offset data 224, bucket data 228, a value index 230, and value payload data 232. In some cases, a data structure 200 may include fewer components, such as no value payload data 232 or no value payload 232 and no value index 230. While the components of the data structure 200 are shown in a particular in FIG. 2, they may be structured in different orders. However, the order depicted in FIG. 2 may provide benefits in processing speed and compression, as the beginning and end of various sections of the data structure 200 can be automatically inferred and need not be separately stored.

The metadata 222 can include information about the data structure 200 and how the data structure is set up to be used. For example, metadata 222 may include header information indicating that the data following is associated with a data structure as described herein; optionally, a number of keys stored in the data structure 200, the number of buckets used, the number of secondary hash functions used, the number of indexed and/or embedded categories; an offset (e.g., address) of the values index; an offset (e.g., address) of the value payload data. Metadata 222 can be stored in any suitable format, such as consecutive integers (e.g., 4-byte integers).

The bucket offset data 224 can include information about the location of the first bucket within the bucket data 228, as well as the location of subsequent buckets. The bucket offset data 224 can immediately follow the metadata 222. For each bucket in the bucket data 228 after the first bucket, the bucket offset data 224 can include an offset from the previous bucket's starting location. The first bucket's starting location can be encoded in the metadata 22 or bucket offset data 224, or can be inferred from the end of the bucket offset data 224. For example, if three buckets were used having sizes of 10, 20, and 35, the bucket offset data 224 may include only entries for “10” and “15,” and the system can infer that the first bucket starts immediately after the last entry in the bucket offset data 224 (e.g., entry for the last bucket: “15”) and the second bucket starts at an offset of 10 from that location, and the third bucket starts at an offset of 15 from that location. In some cases, the bucket offset data 224 can include a trailing value 226. The trailing value 226 can be a value used to determine the end of the bucket data 228, such as an indication of the size of the final bucket and/or a location of the end of bucket data 228. In some cases, the end of bucket data 228 can be inferred from the start of the value index 230, which can be encoded in the metadata 222.

The bucket data 228 component of data structure 200 is depicted in schematic expanded view for illustrative purposes in FIG. 2. The bucket data 228 can immediately follow the bucket offset data 224. The bucket data 228 can include a set of buckets 242, which can include one or more individual buckets 234. As depicted in FIG. 2, the bucket data 228 can include m buckets ranging from bucket “0” to bucket “m-1”. Each bucket 234 can contain further data, as described in further detail herein.

The value index 230 component of data structure 200 is depicted in schematic expanded view for illustrative purposes in FIG. 2. The value index 230 can immediately follow the bucket data 228. The value index 230 can include one or more entries that match value index items 236 with value index locations 248. The value index locations 248 may be stored as separate values within the value index 230, or may be inherent in the structure of the value index 230. For example, a value index 230 can take the form of a sequential list of value index items 236 stored in any suitable form, such as integers (e.g., 4 byte integers). Thus, the fourth entry in the list is the value index item 236 associated with a value index location 248 of 3, assuming the first entry in the list is associated with a value index location 248 of 0. The value index 230 can have a total of z value index locations 248 ranging from 0 to z-1, and thus a total of z value index items 236.

As described herein, each value index item 236 can include value information in various forms. In some cases, the value index item 236 can include the category information itself, such as a piece of data that is indicative of a category itself or is discernable by the querying system (e.g., by translating using a module separate from the data structure 200) as a particular category. In some cases, the value index item 236 can include an address, offset, or pointer to the location of the category information. For example, a value index item 236 can contain an integer indicative of a location of a piece of value information (e.g., value information 238) in the value payload data 232. In some cases, the value index item 236 stores an offset to the desired piece of value information within the value payload data 232 from the end of the value index 230 or from the beginning of the value payload data 232.

As described herein, the value index items 236 in the value index 230 can be stored in an order that is sorted from most common value (e.g., most common category) to least common.

The value payload data 232 component of data structure 200 is depicted in schematic expanded view for illustrative purposes in FIG. 2. The value payload data 232 can immediately follow the value index 230. The value payload data 232 can contain value information (e.g., value information 238, 240) for the key-value pairs stored in the data structure 200. The value payload data 232 permits value information to be stored in any format or size necessary. For example, value information 238 may be much smaller than value information 240, and thus require less storage space.

In some cases, a piece of value information 238 may include information about its end location. However, in some cases, the value payload data 232 is structured such that each sequential value index item 236 in the value index 230 is associated with sequential pieces of value information in the value payload data 232. In such cases, the size of a piece of value information in the value payload data 232 can be inferred by the start location of the subsequent piece of value information, which can be obtained from the subsequent value index item 236.

In some cases, the value payload data 232 can be stored in an order that is sorted from most common value (e.g., most common category) to least common. In some cases, if the value index 230 is also sorted in a similar fashion, sequential value index items 236 in the value index 230 may refer to sequential pieces of value information in the value payload data 232.

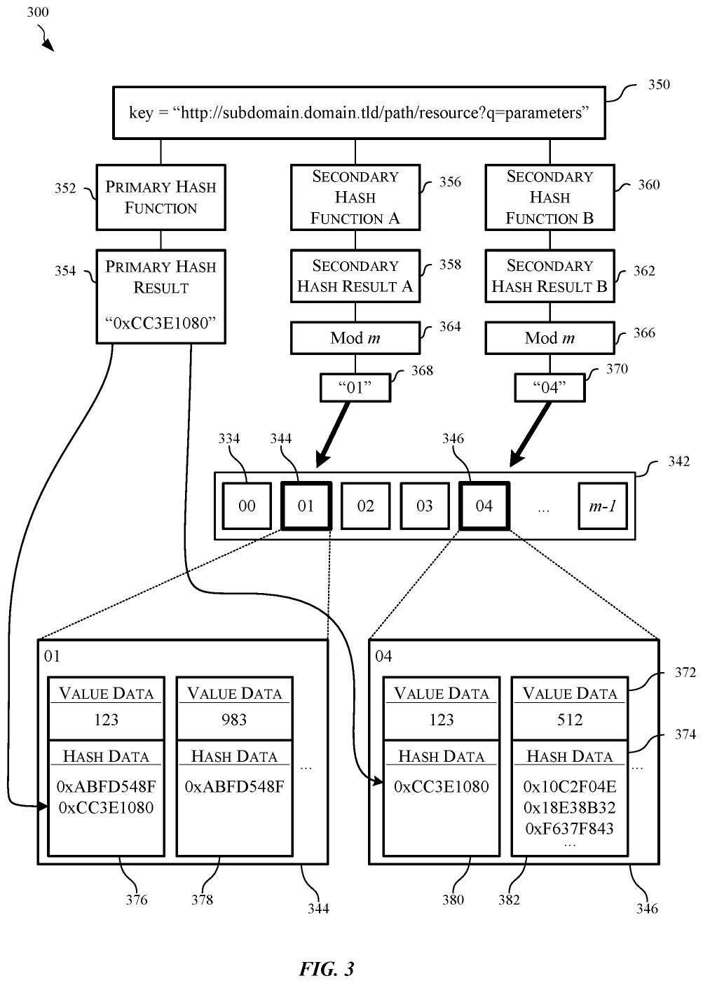

FIG. 3 is a schematic diagram depicting interactions 300 with a portion of a data structure 300 according to certain aspects of the present disclosure. The interactions depicted in FIG. 3 are illustrative of querying a data structure or generating a data structure, as appropriate. The portion of data structure of FIG. 3 can be a portion of data structure 200 of FIG. 2.

A key 350 can be obtained through any suitable technique. In some cases, key 350 is associated with an internet resource, such as a website. The key 350 can be any unique identifier for the internet resource, such as a URI or URL. As depicted in FIG. 3, key 350 is the URL http://subdomain.domain.tld/path/resource?q=parameters

Key 350 can be hashed by a primary hash function 352 to obtain a primary hash result 354, depicted in FIG. 3 as “0xCC3E1080.” Additionally, key 350 can be hashed by a set of secondary hash functions to obtain secondary hash results. The set of secondary hash functions can include one or more hash functions. As depicted in FIG. 2, the set of secondary hash functions includes secondary hash function A 356 and secondary hash function B 360 that result in secondary hash result A 358 and secondary hash result B 362, respectively. Each hash function of the set of secondary hash functions can be a different hash function from each other of the set of secondary hash functions. Each hash function of the set of secondary hash functions can be a different hash function from the primary hash function. The primary hash function 352 can be performed before, simultaneously with, or after the set of secondary hash functions.

Individual buckets 334 of a set of buckets 342 can be selected using the set of secondary hash results (e.g., secondary hash result A 358 and secondary hash result B 362). Any suitable technique can be used, such as using a modulo calculation to assign a given input to a bucket 334 of the set of buckets 342. Each hash result of the set of secondary hash results can be computed using a modulo calculation where the hash result is the dividend and the number of buckets (e.g., m) is the divisor. Thus, secondary hash result A 358 and secondary hash result B 362 can be applied to respective modulo calculations 364, 366 to obtain respective bucket identifiers 368, 370. Bucket identifier 368 is shown to be “01” and bucket identifier 370 is shown to be “04.” Bucket identifier 368 is associated with bucket 334 of the set of buckets 342 and bucket identifier 370 is associated with bucket 346 of the set of buckets 342. Buckets 342, 346 are depicted in exploded form in FIG. 3 for illustrative purposes to show example contents, however it will be understood that some or all other buckets 334 of the set of buckets 342 may contain other contents.

Bucket 334 is shown as containing multiple payloads, including payload 376 and payload 378. Similarly, bucket 346 is shown as containing multiple payloads, including payload 380 and payload 382. Each payload can include respective value data 372 and hash data 374. The value data 372 for a payload contains information associated with a particular value that is associated with the particular keys encoded into that payload. The hash data 374 for a payload contains the primary hash results (e.g., primary hash result 354) of all keys encoded into that payload. When querying a data structure, the payload is inspected to determine if the primary hash result of the key being queried exists in the payload. When building a data structure, the payload can be generated or updated to include the primary hash result of the key being queried, along with the associated value data for the value associated with the key.

As depicted in FIG. 3, primary hash result 354 appears in both payload 376 and payload 380. Further, both payloads 376, 380 can be considered to be value-data-matched payloads because the value data 372 for each of the payloads 376, 380 is the same. A single bucket 334 cannot contain multiple payloads having the same value data, because any new primary hash results that are to be associated with a particular value data would be added to a single payload. Thus, value-data-matched payloads are always spread across multiple buckets.

As described in further detail herein, value data 372 can be stored in a bit-shifted format along with a special value indicative of the number of primary hash results to be found in the hash data 374. In such cases, two payloads can be considered to be value-data-matched when the value data 372, irrespective of any special value indicative of the number of primary hash results, is identical. Thus, two value-data-matched payloads can have different numbers in the integer storing the value data 372. For example, a first payload beginning with an integer indicating “434” and a second beginning with an integer indicating “436” may be value-data-matched if the first payload contains two hash results (e.g. “434”=“54” bit shifted to the left by 3 bits and add “2” for the number of hash results), and the second contains four hash results (e.g. “436”=“54” bit shifted to the left by 3 bits and add “4” for the number of hash results). For illustrative purposes, the value data 372 for payloads 376, 378, 380, 382 of FIG. 3 are depicted without bit shifting or special values.

Hashing collisions will very rarely, if ever, cause any false positives because of the way the data structure is structured. A false positive occurs only if the primary hash result for a given key is present in value-data-matched payloads across all buckets identified by the set of secondary hash results. Thus, a false positive must include collisions in all hash functions simultaneously, as well as a collision in value data for the payloads in which the primary hash functions are found within the identified buckets.

A data structure as disclosed herein can achieve probabilistic storage of key-value associations with a negligible false-positive probability. A negligible false-positive probability can be a false-positive probability that is at or below 0.01, 0.0099, 0.0098, 0.0097, 0.0096, 0.0095, 0.0094, 0.0093, 0.0092, 0.0091, 0.009, 0.0089, 0.0088, 0.0087, 0.0086, 0.0085, 0.0084, 0.0083, 0.0082, 0.0081, 0.008, 0.0079, 0.0078, 0.0077, 0.0076, 0.0075, 0.0074, 0.0073, 0.0072, 0.0071, 0.007, 0.0069, 0.0068, 0.0067, 0.0066, 0.0065, 0.0064, 0.0063, 0.0062, 0.0061, 0.006, 0.0059, 0.0058, 0.0057, 0.0056, 0.0055, 0.0054, 0.0053, 0.0052, 0.0051, 0.005, 0.0049, 0.0048, 0.0047, 0.0046, 0.0045, 0.0044, 0.0043, 0.0042, 0.0041, 0.004, 0.0039, 0.0038, 0.0037, 0.0036, 0.0035, 0.0034, 0.0033, 0.0032, 0.0031, 0.003, 0.0029, 0.0028, 0.0027, 0.0026, 0.0025, 0.0024, 0.0023, 0.0022, 0.0021, 0.002, 0.0019, 0.0018, 0.0017, 0.0016, 0.0015, 0.0014, 0.0013, 0.0012, 0.0011, 0.001, 0.0009, 0.0008, 0.0007, 0.0006, 0.0005, 0.0004, 0.0003, 0.0002, and/or 0.0001. In some cases, the probability of a false-positive for a data structure as disclosed herein can be capped at an upper bound, such as no more than 100, 90, 80, 70, 60, 50, 40, 30, 20, 15, 10, 9, 8, 7, 6, 5, 4, 3, 2, or 1. To achieve a desired false-positive rate, the number of total buckets and/or the number of secondary hashes can be adjusted.

B. Data Structure Generation

The data structure can be generated in advance and distributed to devices for further use. The data structure can be distributed in any suitable way, including through firmware updates (e.g., included as part of a device's firmware) or hardware updates (e.g., included as part of a device's hardware, such as in read-only memory of the device). Generation of the data structure can be performed on any suitable device, although high-performance computers can be leveraged to achieve an efficient data structure.

A mapping of keys to values will be used to generate the data structure, along with a set of adjustable parameters. The adjustable parameters can include parameters such as number of secondary hashes, choices of hashing algorithms, and target number of entries per bucket.

The mapping can be analyzed to determine whether and how the value information can be encoded. As described herein, value information can be directly stored within payloads of buckets, can be stored as entries in a value index, or can be stored in separately addressable value payload data. In some cases, values that are large (e.g., long strings of text or even images) can be stored in value payload data, whereas relatively short values (e.g., category identifiers or short strings of text) may be stored in the value index. In some cases, if the number of secondary hashes used is sufficiently small and the values are sufficiently small, it can be advantageous to store the values directly in the payloads. The value index and/or value payload data can be populated accordingly.

When a value index is used, with or without value payload data, the value index can be sorted by frequency in increasing order. Thus, the most common values (e.g., most common categories) can have the lowest, and thus shortest, index values, which can help optimize storage space. After the values from the mapping are analyzed and encoded, value data can exist for each key. This value data will be stored in the set of buckets, associated with respective primary hashes of associated keys.

The number of buckets to use can be computed based on the number of secondary hashes and the target number of entries per bucket. Computing the number of buckets can include rounding up to the nearest odd number and/or nearest prime number.

The buckets can be populated with necessary payloads by processing the various keys and their associated value data. As each key is analyzed, new payloads can be added to empty buckets, additional payloads can be added to non-empty buckets, or existing payloads can be updated with new primary hash results for that given key.

During bucket population, primary and secondary hashes are performed on each key. The secondary hashes for a given key are used to identify particular buckets from the overall set of buckets. If an identified bucket contains no payloads or contains existing payloads for different value data, a new payload can be generated based on the value data for that particular key and the primary hash result of the particular key. If an identified bucket contains a payload with the same value data as that of the particular key, that payload can be updated to include the primary hash result of that particular key. Updating the payload can include updating any metadata or other indicators identifying the number of payload hash results within that payload.

Once all of the keys have been analyzed and the full set of buckets has been generated, the entire data structure can be compiled together, including the bucket data, the value index, and the value payload data. The data structure can start with metadata, such as information about the data structure generally, the number of keys stored in the data structure, the number of buckets used in the data structure, the number of secondary hashes used in the data structure, the number of indexed values used or the number of embedded values used (e.g., a single integer can provide an indicator of the number of values and whether or not they are indexed or embedded by providing either a positive or negative number), an offset to the value index, an offset to the payload data, or other such metadata.

Bucket offset information can be stored as part of or separate from (e.g., subsequent to) the metadata. The bucket offset data can identify the start location of the first bucket and offsets for the start location of each subsequent bucket. In this fashion, the lengths of each bucket need not be separately stored, since they can be calculated from the starting location of the first and subsequent bucket. The final bucket length can be calculated from based on the starting location of the next block of data, which may be the value index. In some cases, however, the bucket offset data can also include the final bucket end location or a final bucket length.

The fully compiled data structure can have any suitable number of components in any suitable order, although in some cases it will include metadata, bucket offset data, bucket data, an optional value index, and optional value payload data.

After a data structure has been compiled, it can optionally be tested and/or recreated. Testing can include testing known keys for collisions. If collisions are found, the data structure can be recreated using different parameters, such as a different number of buckets, different hashing algorithms, or different number of secondary hashes. In some cases, testing can additionally or alternatively include determining a storage efficiency (e.g., storage space required per key) and/or a speed efficiency (e.g., average time to obtain a value for a given key). If the storage efficiency and/or speed efficiency are below target efficiency levels, the data structure can be recreated using different parameters to try and achieve improved efficiency. In some cases, multiple data structures can be created using multiple parameters and those data structures can be compared, with the most efficient structure being selected for distribution and further use. In some cases, speed efficiency may be more important than storage efficiency (e.g., when more storage is readily available, such as on a smartphone or laptop), whereas storage efficiency may be more important than speed efficiency in other circumstances (e.g., when storage space is scare, such as on a smartwatch). In some cases, speed efficiency can be tested against a set of most-common keys (e.g., websites visited most often).

C. Data Structure Usage

Using the data structure involves using a given key and analyzing the data structure to determine a value associated with the key, if one exists. The data structure can be initialized, such as by reading and verifying any header information (e.g., to confirm the entire data structure is not corrupted) or metadata. This initialization step allows the system using the data structure to know how many hashes to perform, how many buckets exist, the location of different components of the data structure, and the like.

To look up a given key, primary and secondary hashes of the given key are computed. The set of secondary hash results is used to identify a set of buckets from all available buckets. Optionally, the buckets can be processed in ascending order of size to optimize testing times, since any identified bucket with no matching primary hash results is indicative that the key is not stored in the data structure (e.g., because if a key is stored in the data structure, a payload will exist with its primary hash result in each bucket identified by the set of secondary hash results).

For each bucket, the payloads within are reviewed to determine if the payload contains the primary hash result. If each identified bucket contains a payload containing the primary hash result and matching value data, that value data can be used to obtain the value information (e.g., the value) for the key. In some cases, a key can be associated with multiple values, in which case there may be multiple payloads in each bucket that each contain the primary hash result.

During analysis of the identified buckets, if a payload containing the primary hash result is not found in any identified buckets, it can be determined that the given key is not encoded within the data structure and that no value information is known for the given key. The process can end there, returning nothing or returning an indication that no category is found. Optionally, a proposed category can be returned, such as proposed category generated through domain name extraction, as described in further detail herein.

During analysis of the identified buckets, if a payload is found in a first bucket to contain the primary hash result, but no payload is found in one or more other buckets that contains the primary hash result and value data that matches the payload from the first bucket, than it can be determined that the given key is not encoded within the data structure and that no value information is known for the given key. The process can end there, returning nothing or returning an indication that no category is found. Optionally, a proposed category can be returned, such as proposed category generated through domain name extraction, as described in further detail herein.

Analysis of the identified buckets can be optimized by identifying the value data for any payloads that contain the primary hash result in the first identified bucket, then using that identified value data to rapidly exclude every payload in subsequent buckets that does not contain the same value data. Thus, the hash data (e.g., primary hash results) for numerous non-matching payloads can be skipped without being compared to the primary hash result of the given key.

In some cases, analysis of identified buckets can be performed by generating a candidate set C (e.g., a set of tuples for pairs of primary hash results and value indexes) for each bucket. This candidate set C can be generated by adding to it all tuples from a first bucket, ignoring any tuples that do not contain the primary hash result, then intersecting the candidate set C with all tuples from each subsequent identified bucket, ignoring any tuples that do not contain the primary hash result. The candidate set C can thus include a list of all value data associated with the primary hash result.

For each piece of value data identified through analyzing the buckets, the system can extract the necessary value information. As described herein, the value information can be stored within the value data, stored within a value index, or stored within value payload data. For example, if the metadata for the data structure indicates the values are embedded within the value index, the system can know to use the value data to identify the proper index location within the value index and return the value information associated with that index location. In another example, if the metadata for the data structure indicates the values are not embedded within the value index, the system can know to use the information from the value index to identify value information within the value payload data.

D. Examples of Data Structure Usage and Generation

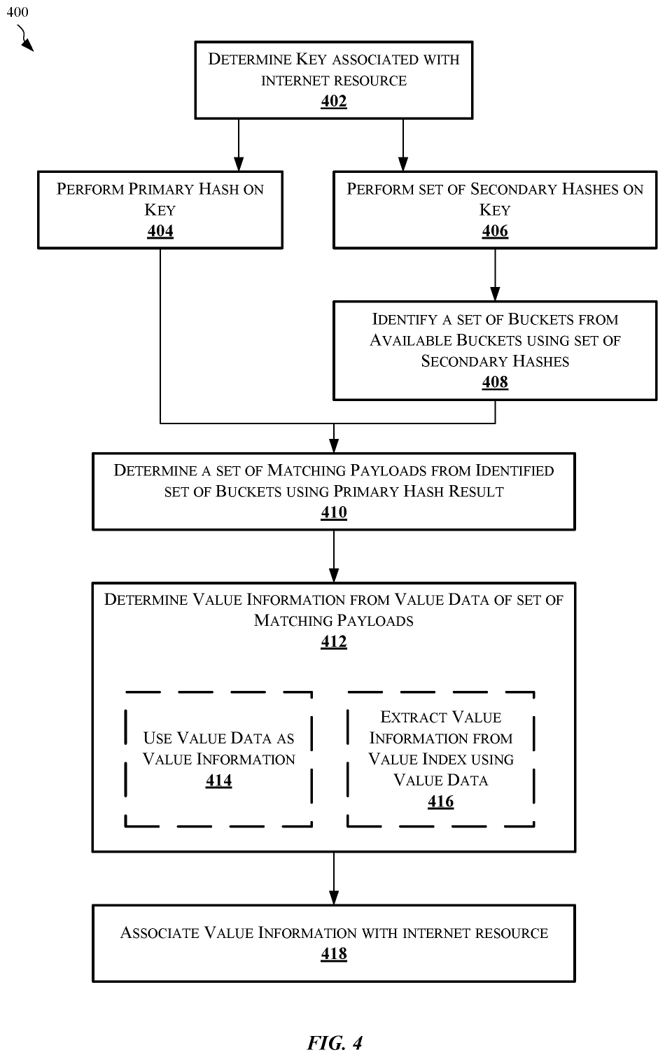

FIG. 4 is a flowchart depicting a process 400 for querying a data structure according to certain aspects of the present disclosure. Process 400 can be used to query data structure 200 of FIG. 2 or any suitable data structure.

At block 402, a key can be determined. The key can be associated with an internet resource. The key can be provided from a separate module of a device's operating system, such as from a web browsing application. The key can be any suitable key, such as a URI or URL associated with an internet resource, such as a website. In some cases, determining a key 402 can include pre-processing the key according to a preset rule, such as to format certain keys to a standard format. For example, pre-processing a key can include converting all capital letters to lowercase letters.

At block 404, a primary hash can be performed on a key to obtain a primary hash result. The primary hash performed at block 404 can be based on a predetermined hashing function.

At block 406, a set of secondary hashes can be performed on the key to obtain a set of secondary hash results. The set of secondary hash functions can include one or more secondary hash functions. At block 408, the set of secondary hash results can be used to identify a set of buckets from the set of buckets (e.g., from all available buckets in the data structure). In some cases, identifying the set of buckets can include using the primary hash result from block 404, although generally the primary hash result will not be used to identify the set of buckets.

At block 410, a set of matching payloads is determined based on the identified set of buckets and using the primary hash result. The matching payloads identified at block 410 can be one or more sets of payloads that are value-data-matched payloads (e.g., having identical value data) and that contain the primary hash result within the hash data of the payload. In some cases, the buckets identified at block 408 may contain multiple sets of matching payloads, such in some cases when there are multiple categories associated with the given key.

Determining a set of matching payloads can include searching for the primary hash result from block 404 within the payloads of the buckets identified at block 408. In some cases, only a single bucket identified at block 408 (e.g., the smallest bucket) may be initially searched to find payloads with matching primary hash results. For all payloads with matching primary hash results, the value data for those payloads can be used to search for value-data-matched payloads in the remaining buckets of the identified set of buckets from block 408. Thus, the hash data in each payload from these remaining buckets need not be searched, and only payloads found to be value-data-matched payloads are searched. Other searching methodologies can be used to identify a set of matching payloads.

At block 412, value information from the value data of the matching payloads is determined. The value information can be a category or other piece of information associated with the value that is associated with the given key. Determining value information at block 412 can include using the value data itself as the value information at block 414. Alternatively, determining value information at block 412 can include extracting value information from a value index using the value data at block 416. Extracting value information from the value index can include using the value data to identify a particular location in the value index (e.g., a particular value index item). In some cases, the identified value index item will contain the value information (e.g., a category or a value indicative of a category). In other cases, the identified value index item will contain an offset, address, or pointer to a location (e.g., value payload data) containing the value information.

At block 418, the value information obtained at block 412 is associated with the internet resource of block 402. Associating a piece of value information with the internet resource can include generating a response transmission using the value information. The response transmission can be sent as a returned value to the module that queried the data structure. In some cases, associating a piece of value information can include storing the value information, with or without the associated key.

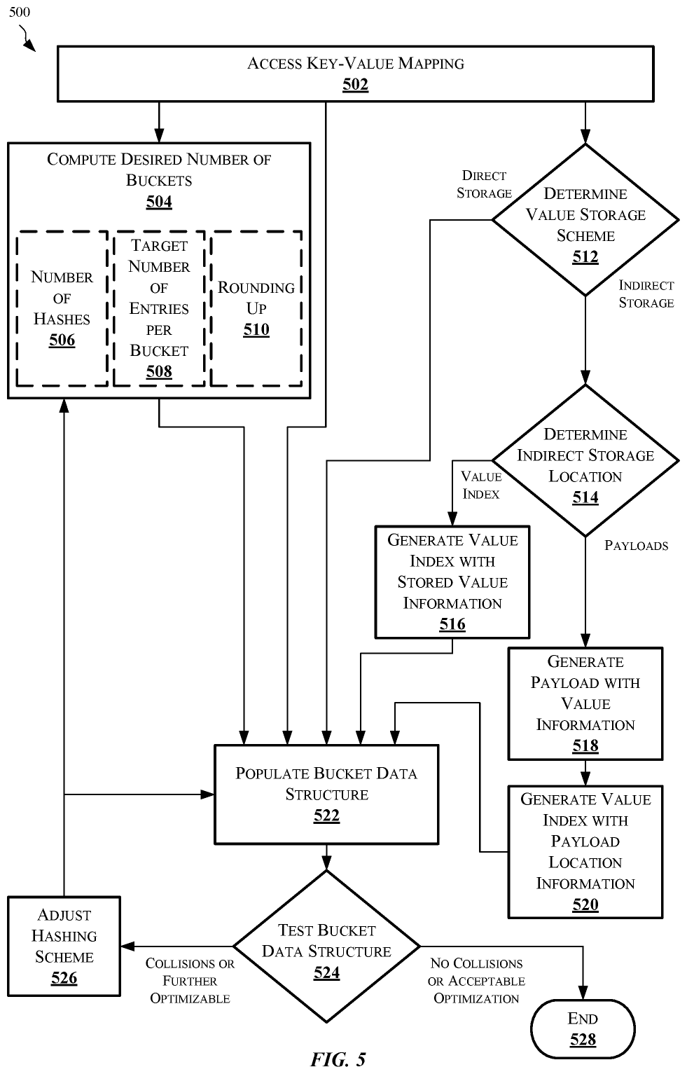

FIG. 5 is a flowchart depicting a process 500 for generating a data structure according to certain aspects of the present disclosure. Process 500 can be used to generate data structure 200 of FIG. 2 or any suitable data structure. At block 502, a mapping of key-value entries is accessed. The mapping can contain any suitable number of values and keys, as well as any suitable number of key-value pairings. The mapping can be mapping 105 of FIG. 1.

At block 504, the desired number of buckets is computed. Computing the desired number of buckets can be based on a number of hashes at block 506 and a target number of entries per bucket at block 508. The number of hashes at block 506 can be a preset or user-provided value that identifies the number of secondary hashes to perform, which correlates with the number of buckets used to store a single key-value entry. The target number of entries per bucket at block 508 can be a preset or user-provided value. In some cases, a target number of entries per bucket at block 508 can be a target number of entries per secondary hash result. The number of buckets can be calculated by dividing the number of key-value entries at block 502 by the target number of entries per bucket 508. In some cases, the number of buckets can be calculated by dividing an reduced version of number the key-value entries at block 502 by the target number of entries per bucket 508. In such cases, the reduced number of the key-value entries at block 502 can be calculated after determining a value storage scheme, since some storage schemes can reduce the number of key-value entries that will end up being stored in the set of buckets, as described in further detail herein. In some cases, computing the desired number of buckets at block 504 can include rounding up at block 510. Rounding up at block 510 can include rounding up to the next odd number or rounding up to the next prime number.

At block 512, the type of value storage scheme is determined. The value storage scheme can be either direct storage within the bucket data structure or indirect storage (e.g., using a value index). The storage scheme can be determined based on the complexity of the values (e.g., categories). If the values are not complex (e.g,. single integer values), they may be able to be more efficiently encoded directly into the bucket data structure rather than encoded using index locations to a value index. If a direct storage scheme is selected at block 512, the bucket data structure can then be populated at block 522.

If an indirect storage scheme is determined at block 512, the storage location for the indirect storage scheme can be determined at block 514. In some cases, the value information at be stored directly within a value index, with the value index items each containing the value information (e.g., categories). In such cases, the process 500 can continue at block 516 with generating the value index using the values from the mapping of block 502. The value index generated at block 516 can be considered a value index with stored value information. After the value index has been generated at block 516, the bucket data structure can be populated at block 522.

In some cases, if an indirect storage scheme is determined at block 512, it can be determined at block 514 to use payloads to store the value information, instead of storing the value information directly within a value index. In such cases, the process 500 can continue with generating value payload data at block 518. Value payload data generated at block 518 can include storing the various values from the mapping 502 into a value payload data component. At block 520, a value index is generated with payload location information according to the various value information entries generated in the value payload data component at block 518. After generating the value payload data and the value index, the process 500 can continue with populating the bucket data structure at block 522.

As disclosed in further detail herein, the various techniques for storing value information at block 522 (e.g., in the case of a direct storage determination at block 512) and blocks 516, 518, 520 can each include processing the value information from the mapping from block 502 to optimize the number of key-value entries stored within the bucket data structure. Optimization techniques are described in further detail herein. For example, hierarchical traversal techniques and value extraction techniques can be used to reduce the number of values stored within the data structure and/or reduce the size of the bucket data structure. Additionally, value sorting from most common to least common can be used to further optimize the speed of querying the data structure.

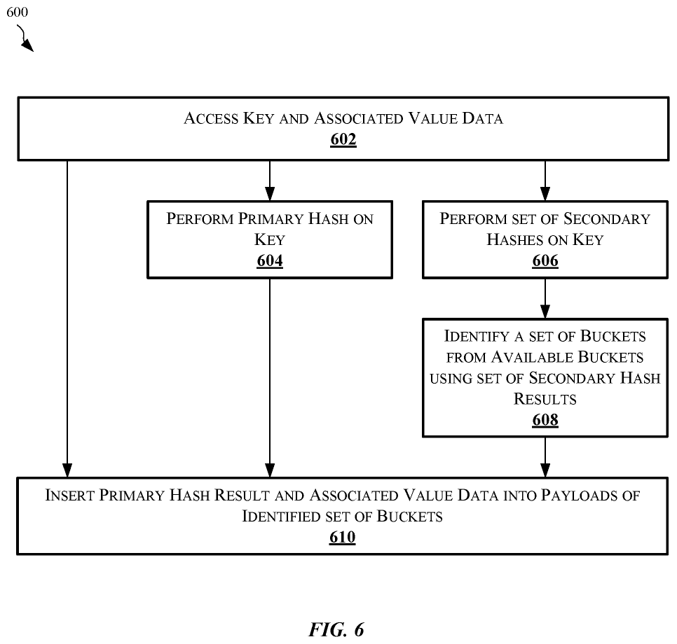

At block 522, the bucket data structure can be populated. The number of buckets computed at block 504 and the number of hashes provided at block 506 can be used. The bucket data structure can be populated using the key-value pairs from the mapping at block 502. Depending on which value is to be mapped into the bucket data structure and the storage scheme and storage location determined at blocks 512, 514, respectively, the bucket data structure will populate the value data of its payloads either with directly stored value information (e.g., categories) or with index locations of the value index items containing or otherwise associated with the value information. Further, as disclosed in further detail herein, the value data can be modified to include any suitable special values for further optimization. Additional details of populating the bucket data structure at block 522 are described in further detail herein, including with respect to FIG. 6.

After the bucket data structure is populated at block 522, it can optionally be tested at block 524. In some cases, testing at block 524 can include testing the bucket data structure generated at block 522 to determine if any collisions exists with known keys (e.g., a set of holdout keys, a subset of keys from the mapping from block 502, or all keys from the mapping from block 502). If no collisions exist, the process 500 can end at block 528. If collisions exist, the process 500 can continue to block 526 where the hashing scheme can be adjusted. In some cases, testing the bucket data structure at block 524 can include testing the bucket data structure for optimization. If it is determined that further optimization is available (e.g., by comparing storage size and/or query speed to a target value or an alternate key-value data structure), the process 500 can continue to block 526 where the hashing scheme can be adjusted.

At block 526, the hashing scheme can be adjusted to generate a new bucket data structure that may occupy less space and/or handle queries faster (e.g., common or expected queries). Adjusting the hashing scheme at block 526 can include adjusting parameters used to compute the desired number of buckets at block 504 and/or parameters used to populate the bucket data structure at block 522. Some example parameters that can be adjusted to produce a different bucket data structure given the same mapping can include the number of secondary hashes used, the hashing algorithms used for any of the hashes, the target number of entries per bucket, the number of buckets. Other parameters can be adjusted. After the hashing scheme is adjusted at block 526, a new number of buckets can be computed at block 504 and/or a new bucket data structure can be populated at block 522. In some cases, subsequent testing at block 524 can include testing the new bucket data structure with one or more previously-generated bucket data structures.

FIG. 6 is a flowchart depicting a process 600 for populating the bucket data structure of a data structure according to certain aspects of the present disclosure. Process 600 can be used to populate the bucket structure of data structure 200 of FIG. 2 or any suitable data structure. Process 600 can be the bucket data structure population of block 522 of FIG. 5.

At block 602, a key and its associated value data can be accessed. The value data accessed at block 602 can be direct value information (e.g., in the case of direct embedding of value information into the bucket data structure) or value data indicative of the location of value information (e.g., via a value index, and optionally value payload data). In some cases, the set of keys and associated values accessed at block 602 may be different from the original mapping of key-value pairs, as it may be optimized to reduce the number of entries in the bucket data structure.

At block 604, a primary hash is performed on the key to obtain a primary hash result. At block 606, a set of secondary hashes are performed on the key to obtain secondary hash results. At block 608, a set of buckets is identified from the set of buckets (e.g., all available buckets of the data structure) using the set of secondary hash results obtained at block 606. The hashes performed at blocks 604 and 606 and the identification at block 608 that are used to populate a bucket data structure can be similar or identical to those performed at blocks 404, 406, 408 of FIG. 4 with respect to querying a data structure.

At block 610, the primary hash result from block 604 that is associated from the key of block 602 and the value data from block 602 that is associated with the same key are inserted into the payloads of the identified set of buckets from block 608. At block 610, inserting a primary hash result and its associated value data can occur in different fashions depending on the current state of the bucket into which the primary hash result and value data are being inserted.

In cases where the bucket is empty (e.g., contains no payloads), a first payload will be generated and populated with the value data from block 602 and the primary hash result from block 604. The value data can be bit shifted and a special value of “1” can be added to the value data to indicate that a single primary hash result exists in the payload.

In cases where the bucket is not empty (e.g., contains at least one payload), but no payloads exist in the bucket with value data that matches the value data from block 602, a new, additional payload will be generated and populated with the value data from block 602 and the primary hash result from block 604. The value data can be bit shifted and a special value of “1” can be added to the value data to indicate that a single primary hash result exists in the payload. Testing an existing payload for matching value data can include compensating for any bit shifting and/or special values that may occur in the value data.

In cases where the bucket is not empty and contains a payload with value data that matches the value data from block 602, that payload can be appended with the primary hash result from block 604 and an indicator for the number of primary hash results within the payload can be incremented by one. In cases where the number of primary hash results within the payload is stored within a special value in the value data and the special value has room for incrementation, the special value can be incremented by one. In cases where the number of primary hash results within the payload is stored within a special value in the value data and the special value does not have room for incrementation, the special value can be set to zero and a variable length integer can be inserted after the value data with the number of primary hash results in the payload, including the latest added primary hash result.

The process 600 can be repeated for every pair of keys and associated value data. In some cases, process 600 can be optimized by accessing a sorted list of keys and associated value data at block 602 that includes a list of all value data to be added for a single key. Then, blocks 604, 606, 608 can each be performed once for each key, and block 610 can be repeated once for each item of value data in the list of value data for that particular key.

As described above, one aspect of the present technology relates to the gathering and use of data available from various sources to identify values (e.g., categories) associated with the gathered data, such as to help categorize websites. The present disclosure contemplates that in some instances, this gathered data may include personal information data that uniquely identifies or can be used to contact or locate a specific person. Such personal information data can include demographic data, location-based data, telephone numbers, email addresses, twitter handles, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver useful insight about the websites visited on a device or servers accessed by the device, such as via a dedicated application (e.g., Facebook). Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing the categories of websites visited or servers accessed, the present technology can be configured to allow users to select to “opt in” or “opt out” of participation in the collection of personal information data during registration for services or anytime thereafter. In another example, users may opt to view and not store category information about websites visited. In yet another example, users may selected a length of time category information for websites visited is stored. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, website category information can be obtained according to certain aspects of the present disclosure locally on the device. As another example, website category information can be provided as a separate lookup tool permitting a user to look up category information for a website without the tool being associated with any actual usage data of the device (e.g., without the tool knowing whether the website provided by the user was ever visited). In some cases, keys provided for querying a data structure as disclosed herein can be based on non-personal information data or a bare minimum amount of personal information, such as the content being requested by the device associated with a user, other non-personal information available to the query module, or publicly available information.

### III. Optimizations

A. Key Hierarchy Optimizations

In some cases, given keys can have inherent hierarchy. For example, websites inherently have a hierarchy associated with their URIs. Certain aspects of the present disclosure can be optimized for handling keys with hierarchies, especially in terms of providing category information for websites or other internet resources. In some cases, the hierarchical nature of a website can be used to extract additional category information for a particular website based on its hierarchy, or to extract category information for a particular website even if that particular website does not have category information stored within the data structure. Traversing a hierarchy can involve attempting to find a value for a given key, then attempting to find a value for a version of the key that has been modified to represent a different level of the hierarchy.

A URI can have various components associated with its different levels of hierarchy. According to an example (“http://subdomain.domain.tld/path/resource?q=parameters”) the URI can have a top level domain (“tld”), a domain (“domain”), a sub-domain (“subdomain”), a path (“/path/”), a resource (“resource”), and further parameters (“?q=parameters”). URIs that are URLs can also have a protocol (“http://”). In some cases, URLs and URIs may have additional components, such as additional levels of sub-domains (e.g., http://one.two.three.domain.tld) or additional levels of paths (e.g., http://subdomain.domain.tld/one/two/three/).

In an example, for the given URL “http://subdomain.domain.tld/path/resource?q=parameters,” the system can initially attempt to resolve category information for the entire URL or URI (e.g., “subdomain.domain.tld/path/resource?q=parameters”). However, if that fails, the system can progressively walk up the hierarchy until category information is obtained (e.g., next going to “subdomain. domain.tld/path/resource?q=parameters” then “subdomain.domain.tld/path/resource” then “subdomain.domain.tld/path/” then “subdomain.domain.tld/” then “domain.tld”). In some cases, the system can automatically traverse a hierarchy in an upwards direction, as shown in the previous example, although that need not always be the case, and in some cases the system can automatically traverse the hierarchy in a downwards direction. In some cases, a hierarchy can be automatically traversed according to a planned pattern that is not linearly up or down the hierarchy, such as subdomain first, then subdomain and resource, then just domain. In some cases, a hierarchy can automatically be traversed only if a particular query fails. In some cases, however, a hierarchy can automatically be traversed to obtain additional value information (e.g., additional categories) based on a given key and the other possible keys in its hierarchy.

In some cases, value data or value information for a particular URI can include a special value for traversing the hierarch of the key. This special value can be used instead of or in conjunction with automatic hierarchy traversal as described above. The special value can be stored in the value data or value index, such as by bit-shifting the value data or the entry in the value index, although it may be stored in other ways and in other locations. The special value can contain directional information indicative of whether to continue up a hierarchy (e.g., an upwards direction), continue down a hierarchy (e.g., a downwards direction), or return nothing. In this fashion, value information for a particular website can be a combination of value information for that particular website's key, as well as value information for some or all of the other possible keys up or down that website's hierarchy.

B. Cross-Protocol Key Optimizations

In some cases, although a given key may include a URI with a particular protocol, the data structure can encode values for that given key along with a similar version of the key structured for a different protocol. For example, a given key with an “ftp://” protocol may be automatically altered to a new version with an “http://” protocol for purposes of extracting category information that is already stored with the “http://” protocol version of the key. For example, if both “ftp://subdomain.domain.com” and “http://subdomain.domain.com” were associated with the categories “Social Media,” and “Photography,” the data structure can encode the key-value entries for the “http://” protocol as usual, then encode the “ftp://” protocol with an instruction to use the categories from the related “http://” protocol. In some cases, this instruction can be encoded as a piece of value data and/or an entry in the value index. In some cases, this instruction can be encoded as a special value embedded in the value data and/or entry in the value index. The special value can be embedded by bit shifting the value data and/or entry in the value index then placing the special value in the bit-shifted region. In some cases, the special value can be associated with one or more rules and/or combination of rules for how to alter the given key to obtain initial and/or additional value information. In some cases, the rule can be to simply strip the protocol information from key. In some cases, the rule can apply a new protocol to the key. In some cases, the rule can include instructions to keep, remove, and/or reorder any elements of the given key.

In an example that combines hierarchy optimizations and cross-protocol optimizations, a data structure as disclosed herein can be used to store category information for apps (e.g., applications) on a device. Each app can be associated with an application bundle identifier (bundleID). BundleIDs can be hierarchical in nature. BundleIDs can take a form similar to a URL, however with a reversed hostname. BundleIDs may also include an “app://” protocol to indicate its usage as a bundlelD. A particular native app on a device can have the bundlelD “app://com.apple.siri.mycoolnewApp.” To query category information for this bundlelD using a data structure as disclosed herein, hierarchical optimzations as disclosed herein can be used. The system can first query using the key “app://com.apple.siri.mycoolnewApp,” then proceed up the hierarchy to “app://com.apple.siri,” then “app://com.apple,” then optionally to “app://com.” In some cases, a special value can be used to inform how to traverse the hierarchy. In some cases, a special value (e.g., the same or a different special value) can be used to perform cross-protocol optimizations. If the special value indicates that an “http://” protocol equivalent lookup is to be performed, the system can automatically alter the given key and query the data structure with that altered key. The key can be altered according to any appropriate technique. For example, the key can be altered to “http://mycoolnewApp.siri.apple.com” or “http://siri.apple.com/mycoolnewApp/” depending on the cross-protocol rule in place. The altered key can then be queried accordingly, which may itself include further hierarchical traversal. Thus, multiple key-value entries that share similar keys that differ in protocol can be stored with fewer value data entries (e.g., fewer payloads) than may otherwise be possible.

As described herein, an application identifier, such as a bundlelD, can be considered associated with an internet resource. In some cases, an application identifier, such as a bundlelD, can be considered associated with an internet resource when at least some of its category data is encoded into the data structure in a fashion associated with another internet resource, such as a website.

C. Value Optimizations

In some cases, further storage and speed optimizations can be achieved by implementing techniques for applying multiple categories through a single value data entry. Thus, multiple key-value entries in the original mapping that all have the same key can be efficiently stored in the data structure using a single piece of value data (e.g., a single set of payloads across the buckets to which that key is associated).

In some cases, the potential values can have an associated hierarchy, which can be leveraged to automatically associate values to a given key based on all values that are higher up in the hierarchy than the value specifically encoded for that key. For example, categories for websites can be stored with information relating to their hierarchy (e.g., a category hierarchy). In an example, a category “Patent Prosecution” may be a sub-category of the broader “Patent Law” category, which may in turn be a sub-category of the broader “Law” category. In such cases, a given key-value mapping may include entries for the key mapping to all three of the example categories. However, since a hierarchical relationship is known between the three categories, the data structure can encode solely the associated between the key and “Patent Prosecution.” Then, when querying the data structure with that key, the “Patent Prosecution” category can be returned, along with its various parent categories (e.g., “Patent Law” and “Law”). In some cases, a special value can be used to indicate whether or not to traverse and/or skip various sub-categories of a category hierarchy.

In some cases, a single value data entry and/or a single entry in a value index can encode, in addition to a piece of value information (e.g., a category), a special value usable to extract additional value information (e.g., a additional category) from the given key. For example, a special value can be stored (e.g., through bit shifting) within a value data entry or the value information of the value index (e.g., the entry in value index associated with the value data). Different values for the special value can be associated with different extraction rules. Therefore, different actions can be taken to extract the additional value information depending on the special value. Such value extraction techniques can be especially useful to encode category information for websites and other internet resources, as useful category information often already occurs within the URI.

In an example, the website “http://www.apple.com” can be used as a key. The data structure can encode an entry in the value index for this key. This entry can include a special value, as well as encoding for a particular category, such as “Technology.” The special value can point to one or more rules that dictate how one or more values can be extracted from the key. In some cases, a rule can indicate that a portion of the domain element or a modified version of the domain element is to be used as a category. In an example, a rule can extract the domain without any subdomains or top level domains, then capitalize the first letter of the result to achieve the category of “Apple.” In some cases, a rule can extract the protocol from a URL to also assign the category of “http://.” In some cases, an extracted protocol can be automatically assigned a particular category, such that if “http://” is seen at the beginning of the key, a category of “Website” is automatically applied. In some cases, a rule can also extract top level domain information, country code domain information, or any other suitable information. In this example, the key-value entries for “http://www.apple.com” with “Technology,” “Apple,” and “Website” can all be encoded using a single piece of value data. In this example, the entry in the value index for the key “http://www.apple.com” can be a binary version of the number 7973, which represents the number 996 bit shifted by three, with the special value 5 in the bit shifted area. The number 996 can encode for the category “Technology” and the special value of 5 can encode for the particular rules used to obtain the “Apple” and “Website” categories, as described above.

In a test mapping of various websites to their assigned categories, it has been found that approximately 30% of the entries can be automatically extracted using these techniques.

In some cases, the special value can encode rules for extracting a particular number of domain elements, such as the last 2 domain elements (e.g., apple.com), the last 3 domain elements (e.g., subdomain.apple.com), the last 4 domain elements (e.g., subsubdomain.subdomain.apple.com), or any other number or combination of domain elements. In some cases, the special value can encode rules for extracting specific domain elements, and optionally formatting them. For example, rules can be used to take the second to last domain element and capitalize it (e.g., “Apple” from subsubdomain.subdomain.apple.com), take the third to last domain element and capitalize it (e.g., “Subdomain” from subsubdomain.subdomain.apple.com), take the fourth to last domain element and capitalize it (e.g., “Subsubdomain” from subsubdomain.subdomain.apple.com), or any other such actions.

In some cases, the special value can be limited to a relatively small value (e.g., 3 bits) due to the need to preserve sufficient size in the entry into which it is encoded. Thus, the number of available rules and/or rule combinations can be limited. For example, with a 3 bit special value, only 7 different rules can be coded, not including a special value for doing no rule (e.g., a special value of zero). Thus, particular rules must be selected to be used. In some cases, the data structure can always use the same set of rules. In some cases, however, a data structure can be further optimized by selecting particular rules that would achieve optimized storage reduction. For example, if a particular mapping of key-value entries contains many entries of a key with a subdomain being mapped to a capitalized version of that subdomain, it can be advantageous to use such a rule to automatically extract that value from the key. Likewise, if that mapping has few or no keys that map the domain of the key to a category with the second letter of that domain capitalized (e.g., “eBay” from “ebay.com”), it may be advantageous to not use such a rule in place of some other rule that may provide better optimization of the data structure. In some cases, the data structure can contain metadata indicative of the particular rules used by the encoded special value.

D. Examples of Optimizations

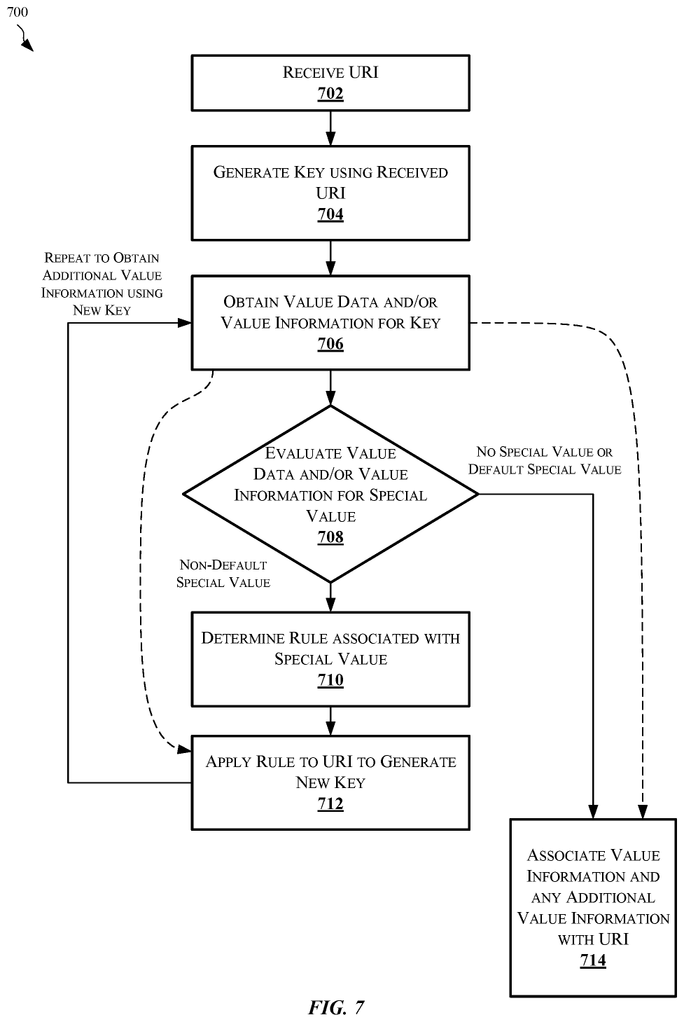

FIG. 7 is a flowchart depicting a process 700 for automatically extracting value information across a hierarchy of a uniform resource identifier according to certain aspects of the present disclosure. Process 700 can be used with data structure 200 of FIG. 2 or any suitable data structure.

At block 702, a URI can be received. At block 704, a key can be generated using the received URI. In some cases, the key can be the entire URI. In some cases, the key can be a preset portion of the URI. For example, in cases of URLs, process 700 can bet set up to initially generate a key that contains only the hostname (e.g., subdomains, domains, and top level domains) and optionally the protocol, stripping off any further paths, resource names, or further data.

At block 706, value data and/or value information is obtained for the key 706. Obtaining the value data and/or value information can include querying a data structure as described herein. At block 708, the value data and/or value information can be evaluated to determine if a special value exists. If no special value exists or if a special value exists that is a default value (e.g., zero), the process 700 can continue at block 714 with associating the value information with the URI from block 702. However, if a non-default special value (e.g., non-zero) exists, the process 700 can continue at block 710. As used herein, the term default special value refers to a value indicative that no further value information need be obtained through process 700 for the URI from process 702. The default special value may not necessarily be zero.

At block 710, a rule can be determined based on the special value from the value data and/or value information. The rules can be stored with or separate from the data structure.

At block 712, the rule is applied to the URI received at block 702 to generate a new key. The rules for generating a new key (e.g., altering the existing key) are disclosed in further detail herein. For example, a rule could generate a new key that moves up or down the hierarchy of the URI, thus generating a new key at the new level of the hierarchy. Upon generating a new key at block 712, the process 700 can repeat starting with obtaining value data and/or value information for the new key at block 706. Thus, blocks 706, 708, 710, 712 can repeat as many times as necessary.

Optionally, in some cases, if no value data and/or value information exists for a particular key at block 706, the process can either skip to block 714 or attempt to apply a rule (e.g., the previously attempted rule, if one was attempted) at block 712 to generate a new key.

In some cases, a rule can cause the value information for a particular level of the hierarchy to not be included when the value information is associated with the URI at block 714.

At block 714, the value information and any additional value information can be associated with the URI from block 702. Associating the value information with the URI at block 714 can be similar to associating value information with the internet resource at block 418 of FIG. 4.

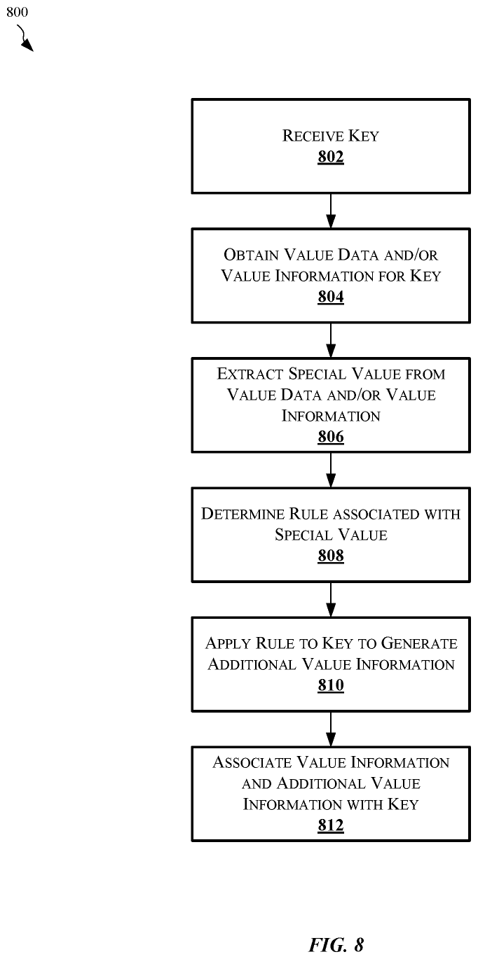

FIG. 8 is a flowchart depicting a process 800 for automatically obtaining multiple pieces of value information for a given key according to certain aspects of the present disclosure. Process 800 can be used with data structure 200 of FIG. 2 or any suitable data structure. At block 802, a key is received. At block 804, value data and/or value information is obtained for the key, such as by querying a data structure as described in further detail herein.

At block 806, a special value is extracted from the value data and/or the value information. At block 808, a rule can be determined based on the special value from block 806. The available rules can be stored with or separate from the data structure. The rule determined at block 808 can provide instructions for generating additional value information, such as generating value information from the received key 802. At block 810, the rule can be applied to the key to generate the additional value information. The rules for generating value information are disclosed in further detail herein. For example, a rule could automatically use the domain name of a URI to generate a capitalized version of the domain name as value information (e.g., a category) associated with that URI.

At block 812, the value information obtained at block 804 and the additional value information generated at block 810 can be associated with the key received at block 802. Associating the value information and additional value information with the key at block 812 can be similar to associating value information with the internet resource at block 418 of FIG. 4.

IV. Further Example Use Cases

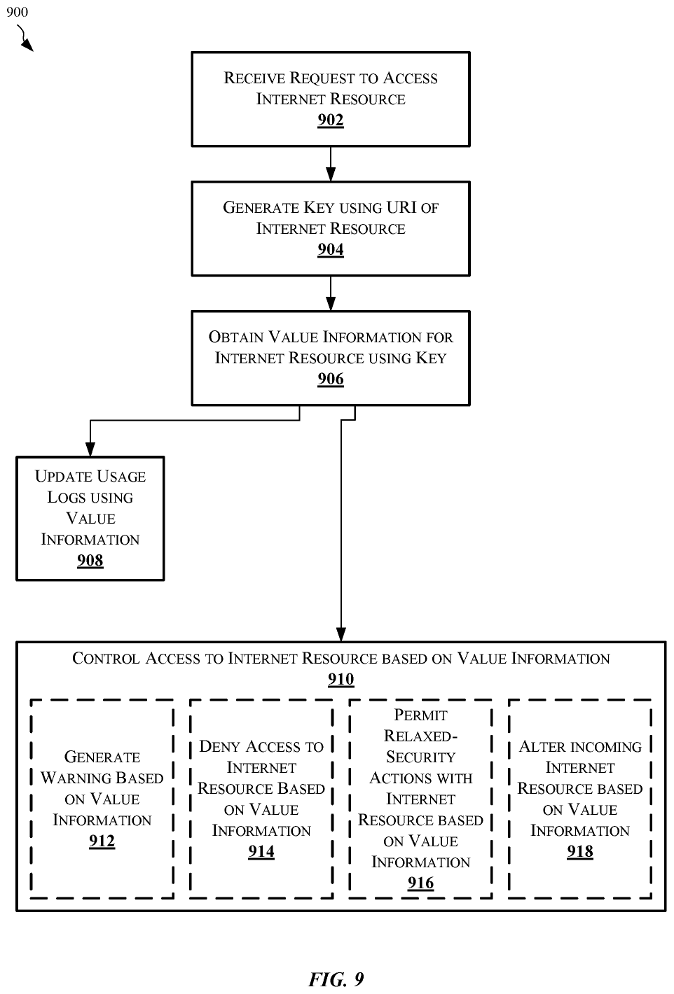

FIG. 9 is a flowchart depicting a process 900 for using value information obtained from a data structure according to certain aspects of the present disclosure. Process 900 can be used with data structure 200 of FIG. 2 or any suitable data structure.

At block 902, a request to access an internet resource can be received 902. The request to access the internet resource can be received in any suitable fashion, such as through a web browser or a native app utilizing an internet connection. The request to access the internet resource can include a URI associated with the internet resource. At block 904, a key can be generated using the URI of the internet resource. Generating the key at block 904 can be similar to generating a key at block 802 of FIG. 8.

At block 906, value information for the internet resource can be obtained using the key generated at block 904. Obtaining value information at block 906 can include querying a data structure as disclosed herein. For example, obtaining value information at block 906 can include performing process 400 of FIG. 4.

At optional block 908, a usage log can be updated using the value information. The usage log can be of any suitable form and can keep a record of the value information. The usage log can include other information associated with the value information, such as date, a timestamp, the URI accessed, or other data associated with the system attempting access to the internet resource. In some cases, the usage log may only be updated at block 908 upon a successful access to the internet resource. In some cases, the usage log 908 can be used to generate an indication of the amount of time spent on various categories of websites.

At optional block 910, access to the internet resource can be controlled based on the value information obtained at block 906. Controlling access to the internet resource can involve permitting access, providing warnings, denying access, permitting access with varying degrees of security, or even altering the incoming internet resource (e.g., altering the webpage). Controlling access can be based on the value information, and optionally other information. In some cases, controlling access at block 910 can be based on a combination of value information from block 906 and usage logs (e.g., historical usage associated with the same value information or other value information) from block 908. In some cases, the value information can be indicative of a safety level (e.g., a threat level) of the internet resource. In some cases, access may wish to be controlled based on a general category (e.g., a parent may wish to limit a child's access to websites categorized as “online gaming” to only a certain amount of time each day or to less time than the child has accessed websites categorized as “educational”).

In some cases, controlling access at block 910 can include generating a warning at block 912 based on the value information. For example, if access is attempted for a website that is known to be suspicious or potentially suspicious, value information indicative that the website is or may be suspicious can be used to cause a warning message to be generated. The warning message can provide information about the suspicious nature of the website and/or can request confirmation that the user still wishes to access that website.

In some cases, controlling access at block 910 can include denying access to the internet resource based on the value information at block 914. For example, if access is attempted for a website that is known to be nefarious, value information indicative that the website is a security concern can be used to deny access to the website.

In some cases, controlling access at block 910 can include permitting relaxed- security actions for certain internet resources based on value information. For example, if access is attempted for a website that is known to be safe or have an especially high degree of security, value information indicative that the website is safe or especially safe can be used to enable certain functionality that may otherwise be ill advised for unknown and/or risky websites. Such functionality can include actions such as autocompletion of forms, such as with personal information and/or payment information. Such functionality can also include permitting the execution of scripts or other executable code on the website.

In some cases, controlling access at block 910 can include altering the incoming internet resource based on the value information. For example, if access is attempted for a website that is known to contain dangerous items, value information indicative of the danger associated with the website can be used to automatically cause the website to be altered, such as by removing all scripts or removing any code that automatically executes upon loading the website.

At block 910, other types of control can be performed based on the value information. In some cases, other actions besides updating usage logs at block 908 and controlling access at block 910 can be performed based on value information obtained at block 906.

In some cases, after obtaining the value information (e.g., a category or topic) for a particular key (e.g., particular website) at block 906, further actions can include using the value information to automatically lookup candidate query suggestions for the particular website. Looking up candidate query suggestions is described in further detail in U.S. Application No. 62/514,660 filed Jun. 2, 2017 entitled “Methods and Systems for Providing Query Suggestions,” the disclosure of which is hereby incorporated by reference.

V. Example Device

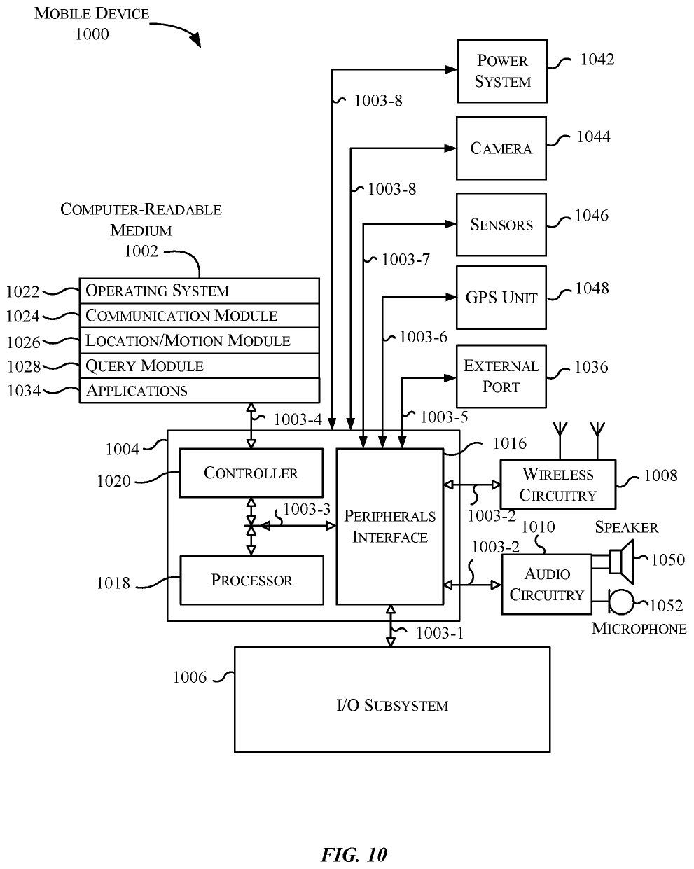

FIG. 10 is a block diagram of an example device 1000, which may be a mobile device, using a data structure according to certain aspects of the present disclosure. Device 1000 generally includes computer-readable medium 1002, a processing system 1004, an Input/Output (I/O) subsystem 1006, wireless circuitry 1008, and audio circuitry 1010 including speaker 1050 and microphone 1052. These components may be coupled by one or more communication buses or signal lines 1003. Device 1000 can be any portable electronic device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 10 is only one example of an architecture for device 1000, and that device 1000 can have more or fewer components than shown, or a different configuration of components. The various components shown in FIG. 10 can be implemented in hardware, software, or a combination of both hardware and software, including one or more signal processing and/or application specific integrated circuits.

Wireless circuitry 1008 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1008 can use various protocols, e.g., as described herein. For example, wireless circuitry 1008 can have one component for one wireless protocol (e.g., Bluetooth®) and a separate component for another wireless protocol (e.g., UWB). Different antennas can be used for the different protocols.

Wireless circuitry 1008 is coupled to processing system 1004 via peripherals interface 1016. Interface 1016 can include conventional components for establishing and maintaining communication between peripherals and processing system 1004. Voice and data information received by wireless circuitry 1008 (e.g., in speech recognition or voice command applications) is sent to one or more processors 1018 via peripherals interface 1016. One or more processors 1018 are configurable to process various data formats for one or more application programs 1034 stored on medium 1002.

Peripherals interface 1016 couple the input and output peripherals of the device to processor 1018 and computer-readable medium 1002. One or more processors 1018 communicate with computer-readable medium 1002 via a controller 1020. Computer-readable medium 1002 can be any device or medium that can store code and/or data for use by one or more processors 1018. Medium 1002 can include a memory hierarchy, including cache, main memory and secondary memory.

Device 1000 also includes a power system 1042 for powering the various hardware components. Power system 1042 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1000 includes a camera 1044. In some embodiments, device 1000 includes sensors 1046. Sensors 1046 can include accelerometers, compasses, gyrometers, pressure sensors, audio sensors, light sensors, barometers, and the like. Sensors 1046 can be used to sense location aspects, such as auditory or light signatures of a location. Sensors 1046 can be used to obtain information about the environment of device 1000, such as discernable sound waves, visual patterns, or the like. This environmental information can be used to determine a key for querying the data structure disclosed herein. For example, an image from a camera 1044 may be used in association with the data structure to determine a value (e.g., category) associated with the image.

In some embodiments, device 1000 can include a GPS receiver, sometimes referred to as a GPS unit 1048. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In some cases, such information related to location can be used to determine a key for querying the data structure disclosed herein. For example, in some cases location information can be used in association with the data structure to determine a value (e.g., category) associated with the location information.

One or more processors 1018 (e.g., data processors) run various software components stored in medium 1002 to perform various functions for device 1000. In some embodiments, the software components include an operating system 1022, a communication module (or set of instructions) 1024, a location module (or set of instructions) 1026, a query module 1028 that is used to query the data structure as disclosed herein, and other applications (or set of instructions) 1034.

Operating system 1022 can be any suitable operating system, including iOS, macOS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1024 facilitates communication with other devices over one or more external ports 1036 or via wireless circuitry 1008 and includes various software components for handling data received from wireless circuitry 1008 and/or external port 1036. External port 1036 (e.g., USB, FireWire, Lightning connector, 60-pin connector, etc.) is adapted for coupling directly to other devices or indirectly over a network (e.g., the Internet, wireless LAN, etc.).

Location/motion module 1026 can assist in determining the current position (e.g., coordinates or other geographic location identifiers) and motion of device 1000. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1026 receives data from GPS unit 1048 and analyzes the signals to determine the current position of the mobile device. In some embodiments, location/motion module 1026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1008 and is passed to location/motion module 1026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1000 based on the position coordinates of the corresponding transmitters. Regardless of the specific location technology used, location/motion module 1026 receives information from which a location fix can be derived, interprets that information, and returns location information, such as geographic coordinates, latitude/longitude, or other location fix data.

Query module 1028 can process a given key using a data structure as disclosed herein, such as data structures 106, 112, 116, 120 of FIG. 1, and/or data structure 200 of FIG. 2. The query module 1028 can receive a key or information associated with a key and perform the various actions described herein to determine a value associated with the key from the data structure and/or determine that the data structure contains no value for the given key. The key can be associated with an internet resource, such as a URI for the internet resource. The value associated with the key can be any suitable value information, such as a category of the internet resource.

The one or more applications programs 1034 on the mobile device can include any applications installed on the device 1000, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The timer module can maintain various timers for any number of events.

The I/O subsystem 1006 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1006 can include a display and user input devices such as a keyboard, mouse, and/or track pad. In some embodiments, I/O subsystem 1006 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1000 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

As used below, any reference to a series of examples is to be understood as a reference to each of those examples disjunctively (e.g., “Examples 1-4” is to be understood as “Examples 1, 2, 3, or 4”).

Example 1 is a system, comprising: one or more data processors; and a non-transitory computer-readable storage medium containing instructions which, when executed on the one or more data processors, cause the one or more data processors to perform operations including: determining a key associated with an internet resource; performing a primary hash on the key to obtain a primary hash result; performing a set of secondary hashes on the key to obtain one or more secondary hash results, wherein the set of secondary hashes comprises one or more secondary hashes; identifying a set of buckets of a data structure using the set of secondary hashes, wherein identifying the set of buckets comprises identifying a bucket for each secondary hash of the set of secondary hashes, wherein each bucket of the identified set of buckets contains one or more payloads, and wherein each payload of the one or more payloads comprises value data and hash data; determining a set of matching payloads from the identified set of buckets using the primary hash result, wherein determining the set of matching payloads comprises identifying a payload from each of the identified set of buckets such that the identified payloads contain matching value data and such that each of the identified payloads includes the primary hash result in the hash data; and determining value information using the matching value data, wherein the value information is indicative of a category associated with the internet resource.

Example 2 is the system of example(s) 1, wherein determining value information using the matching value data comprises accessing a value index of the data structure using the matching value data to determine the value information, wherein the matching value data identifies one or more locations within the value index.

Example 3 is the system of example(s) 2, wherein at least one of the one or more locations within the value index contains location information for a location in the data structure usable to obtain the value information.

Example 4 is the system of example(s) 1-3, wherein the matching value data is the value information.

Example 5 is the system of example(s) 1-4, wherein the internet resource is a website identifiable by a uniform resource identifier, and wherein determining the key comprises using the uniform resource identifier to determine the key.

Example 6 is the system of example(s) 5, wherein determining the key comprises: receiving the uniform resource identifier associated with the website; and extracting a portion of the uniform resource identifier to use as the key.

Example 7 is the system of example(s) 6, wherein the operations further comprise: determining additional value information is available for the uniform resource identifier using the matching value data or the value information; extracting an additional portion of the uniform resource identifier to use as an additional key, wherein the additional portion of the uniform resource identifier is different from the portion of the uniform resource identifier; and determining the additional value information using the additional key.

Example 8 is the system of example(s) 7, wherein determining additional value information is available comprises determining directional information indicative of an upwards direction or a downwards direction in a hierarchy of the uniform resource identifier, and wherein extracting the additional portion of the uniform resource identifier comprises using the directional information.

Example 9 is the system of example(s) 1-8, wherein determining the value information comprises: accessing a special value associated with the matching value data, wherein the special value is indicative that the key contains value information; and extracting at least some of the value information from the key.

Example 10 is the system of example(s) 9, wherein the internet resource is a website identifiable by a uniform resource identifier, wherein the key includes a domain element of the uniform resource identifier, and wherein extracting the at least some of the value information from the key comprises using the domain element or a modified version of the domain element as at least a portion of the category.

Example 11 is the system of example(s) 1-10, wherein the category is indicative of a safety level associated with the internet resource, and wherein the operations further comprise controlling access to the internet resource based on the safety level.

Example 12 is a computer-implemented method, comprising: determining, by a computing device, a key associated with an internet resource; performing a primary hash on the key to obtain a primary hash result; performing a set of secondary hashes on the key to obtain one or more secondary hash results, wherein the set of secondary hashes comprises one or more secondary hashes; identifying a set of buckets of a data structure using the set of secondary hashes, wherein identifying the set of buckets comprises identifying a bucket for each secondary hash of the set of secondary hashes, wherein each bucket of the identified set of buckets contains one or more payloads, and wherein each payload of the one or more payloads comprises value data and hash data; determining a set of matching payloads from the identified set of buckets using the primary hash result, wherein determining the set of matching payloads comprises identifying a payload from each of the identified set of buckets such that the identified payloads contain matching value data and such that each of the identified payloads includes the primary hash result in the hash data; and determining value information using the matching value data, wherein the value information is indicative of a category associated with the internet resource.

Example 13 is the computer-implemented method of example(s) 12, wherein determining value information using the matching value data comprises accessing a value index of the data structure using the matching value data to determine the value information, wherein the matching value data identifies one or more locations within the value index.

Example 14 is the computer-implemented method of example(s) 13, wherein at least one of the one or more locations within the value index contains location information for a location in the data structure usable to obtain the value information.

Example 15 is the computer-implemented method of example(s) 12-14, wherein the matching value data is the value information.

Example 16 is the computer-implemented method of example(s) 12-15, wherein the internet resource is a website identifiable by a uniform resource identifier, and wherein determining the key comprises using the uniform resource identifier to determine the key.

Example 17 is the computer-implemented method of example(s) 16, wherein determining the key comprises: receiving the uniform resource identifier associated with the website; and extracting a portion of the uniform resource identifier to use as the key.

Example 18 is the computer-implemented method of example(s) 17, further comprising: determining additional value information is available for the uniform resource identifier using the matching value data or the value information; extracting an additional portion of the uniform resource identifier to use as an additional key, wherein the additional portion of the uniform resource identifier is different from the portion of the uniform resource identifier; and determining the additional value information using the additional key.

Example 19 is the computer-implemented method of example(s) 18, wherein determining additional value information is available comprises determining directional information indicative of an upwards direction or a downwards direction in a hierarchy of the uniform resource identifier, and wherein extracting the additional portion of the uniform resource identifier comprises using the directional information.

Example 20 is the computer-implemented method of example(s) 12-19, wherein determining the value information comprises: accessing a special value associated with the matching value data, wherein the special value is indicative that the key contains value information; and extracting at least some of the value information from the key.

Example 21 is the computer-implemented method of example(s) 20, wherein the internet resource is a website identifiable by a uniform resource identifier, wherein the key includes a domain element of the uniform resource identifier, and wherein extracting the at least some of the value information from the key comprises using the domain element or a modified version of the domain element as at least a portion of the category.

Example 22 is the computer-implemented method of example(s) 12-21, wherein the category is indicative of a safety level associated with the internet resource, and wherein the method further comprises controlling access to the internet resource based on the safety level.

Example 23 is a computer-program product tangibly embodied in a non-transitory machine-readable storage medium, including instructions configured to cause a data processing apparatus to perform operations including: determining a key associated with an internet resource; performing a primary hash on the key to obtain a primary hash result; performing a set of secondary hashes on the key to obtain one or more secondary hash results, wherein the set of secondary hashes comprises one or more secondary hashes; identifying a set of buckets of a data structure using the set of secondary hashes, wherein identifying the set of buckets comprises identifying a bucket for each secondary hash of the set of secondary hashes, wherein each bucket of the identified set of buckets contains one or more payloads, and wherein each payload of the one or more payloads comprises value data and hash data; determining a set of matching payloads from the identified set of buckets using the primary hash result, wherein determining the set of matching payloads comprises identifying a payload from each of the identified set of buckets such that the identified payloads contain matching value data and such that each of the identified payloads includes the primary hash result in the hash data; and determining value information using the matching value data, wherein the value information is indicative of a category associated with the internet resource.

Example 24 is the computer-program product of example(s) 23, wherein determining value information using the matching value data comprises accessing a value index of the data structure using the matching value data to determine the value information, wherein the matching value data identifies one or more locations within the value index.

Example 25 is the computer-program product of example(s) 24, wherein at least one of the one or more locations within the value index contains location information for a location in the data structure usable to obtain the value information.

Example 26 is the computer-program product of example(s) 23-25, wherein the matching value data is the value information.

Example 27 is the computer-program product of example(s) 23-26, wherein the internet resource is a website identifiable by a uniform resource identifier, and wherein determining the key comprises using the uniform resource identifier to determine the key.

Example 28 is the computer-program product of example(s) 27, wherein determining the key comprises: receiving the uniform resource identifier associated with the website; and extracting a portion of the uniform resource identifier to use as the key.

Example 29 is the computer-program product of example(s) 28, wherein the operations further comprise: determining additional value information is available for the uniform resource identifier using the matching value data or the value information; extracting an additional portion of the uniform resource identifier to use as an additional key, wherein the additional portion of the uniform resource identifier is different from the portion of the uniform resource identifier; and determining the additional value information using the additional key.

Example 30 is the computer-program product of example(s) 29, wherein determining additional value information is available comprises determining directional information indicative of an upwards direction or a downwards direction in a hierarchy of the uniform resource identifier, and wherein extracting the additional portion of the uniform resource identifier comprises using the directional information.

Example 31 is the computer-program product of example(s) 23-30, wherein determining the value information comprises: accessing a special value associated with the matching value data, wherein the special value is indicative that the key contains value information; and extracting at least some of the value information from the key.

Example 32 is the computer-program product of example(s) 31, wherein the internet resource is a website identifiable by a uniform resource identifier, wherein the key includes a domain element of the uniform resource identifier, and wherein extracting the at least some of the value information from the key comprises using the domain element or a modified version of the domain element as at least a portion of the category.

Example 33 is the computer-program product of example(s) 23-32, wherein the category is indicative of a safety level associated with the internet resource, and wherein the operations further comprise controlling access to the internet resource based on the safety level.

What is claimed is:

1. A system, comprising:
one or more data processors; and
a non-transitory computer-readable storage medium containing instructions which, when executed on the one or more data processors, cause the one or more data processors to perform operations including:
determining a key associated with an internet resource;
performing a primary hash on the key to obtain a primary hash result;
performing a set of secondary hashes on the key to obtain one or more secondary hash results, wherein the set of secondary hashes comprises one or more secondary hashes;
identifying a set of buckets of a data structure using the set of secondary hashes, wherein identifying the set of buckets comprises identifying a bucket for each secondary hash of the set of secondary hashes, wherein each bucket of the identified set of buckets contains one or more payloads, and wherein each payload of the one or more payloads comprises value data and hash data;
determining a set of matching payloads from the identified set of buckets using the primary hash result, wherein determining the set of matching payloads comprises identifying a payload from each of the identified set of buckets such that the identified payloads contain matching value data and such that each of the identified payloads includes the primary hash result in the hash data; and
determining value information using the matching value data, wherein the value information is indicative of a category associated with the internet resource.

2. The system of claim 1, wherein determining value information using the matching value data comprises accessing a value index of the data structure using the matching value data to determine the value information, wherein the matching value data identifies one or more locations within the value index.

3. The system of claim 2, wherein at least one of the one or more locations within the value index contains location information for a location in the data structure usable to obtain the value information.

4. The system of claim 1, wherein the matching value data is the value information.

5. The system of claim 1, wherein the internet resource is a website identifiable by a uniform resource identifier, and wherein determining the key comprises using the uniform resource identifier to determine the key.

6. The system of claim 5, wherein determining the key comprises:
receiving the uniform resource identifier associated with the website; and
extracting a portion of the uniform resource identifier to use as the key.

7. The system of claim 6, wherein the operations further comprise:
determining additional value information is available for the uniform resource identifier using the matching value data or the value information;
extracting an additional portion of the uniform resource identifier to use as an additional key, wherein the additional portion of the uniform resource identifier is different from the portion of the uniform resource identifier; and
determining the additional value information using the additional key.

8. The system of claim 7, wherein determining additional value information is available comprises determining directional information indicative of an upwards direction or a downwards direction in a hierarchy of the uniform resource identifier, and wherein extracting the additional portion of the uniform resource identifier comprises using the directional information.

9. The system of claim 1, wherein determining the value information comprises:
accessing a special value associated with the matching value data, wherein the special value is indicative that the key contains value information; and
extracting at least some of the value information from the key.

10. The system of claim 9, wherein the internet resource is a website identifiable by a uniform resource identifier, wherein the key includes a domain element of the uniform resource identifier, and wherein extracting the at least some of the value information from the key comprises using the domain element or a modified version of the domain element as at least a portion of the category.

11. The system of claim 1, wherein the category is indicative of a safety level associated with the internet resource, and wherein the operations further comprise controlling access to the internet resource based on the safety level.

12. A computer-implemented method, comprising:
determining, by a computing device, a key associated with an internet resource;
performing a primary hash on the key to obtain a primary hash result;
performing a set of secondary hashes on the key to obtain one or more secondary hash results, wherein the set of secondary hashes comprises one or more secondary hashes;
identifying a set of buckets of a data structure using the set of secondary hashes, wherein identifying the set of buckets comprises identifying a bucket for each secondary hash of the set of secondary hashes, wherein each bucket of the identified set of buckets contains one or more payloads, and wherein each payload of the one or more payloads comprises value data and hash data;
determining a set of matching payloads from the identified set of buckets using the primary hash result, wherein determining the set of matching payloads comprises identifying a payload from each of the identified set of buckets such that the identified payloads contain matching value data and such that each of the identified payloads includes the primary hash result in the hash data; and
determining value information using the matching value data, wherein the value information is indicative of a category associated with the internet resource.

13. The computer-implemented method of claim 12, wherein determining value information using the matching value data comprises accessing a value index of the data structure using the matching value data to determine the value information, wherein the matching value data identifies one or more locations within the value index.

14. The computer-implemented method of claim 13, wherein at least one of the one or more locations within the value index contains location information for a location in the data structure usable to obtain the value information.

15. The computer-implemented method of claim 12, wherein the matching value data is the value information.

16. The computer-implemented method of claim 12, wherein the internet resource is a website identifiable by a uniform resource identifier, and wherein determining the key comprises using the uniform resource identifier to determine the key.

17. The computer-implemented method of claim 16, wherein determining the key comprises:
receiving the uniform resource identifier associated with the website; and
extracting a portion of the uniform resource identifier to use as the key.

18. The computer-implemented method of claim 17, further comprising:
determining additional value information is available for the uniform resource identifier using the matching value data or the value information;
extracting an additional portion of the uniform resource identifier to use as an additional key, wherein the additional portion of the uniform resource identifier is different from the portion of the uniform resource identifier; and
determining the additional value information using the additional key.

19. The computer-implemented method of claim 18, wherein determining additional value information is available comprises determining directional information indicative of an upwards direction or a downwards direction in a hierarchy of the uniform resource identifier, and wherein extracting the additional portion of the uniform resource identifier comprises using the directional information.

20. The computer-implemented method of claim 12, wherein determining the value information comprises:
accessing a special value associated with the matching value data, wherein the special value is indicative that the key contains value information; and
extracting at least some of the value information from the key.

21. The computer-implemented method of claim 20, wherein the internet resource is a website identifiable by a uniform resource identifier, wherein the key includes a domain element of the uniform resource identifier, and wherein extracting the at least some of the value information from the key comprises using the domain element or a modified version of the domain element as at least a portion of the category.

22. The computer-implemented method of claim 12, wherein the category is indicative of a safety level associated with the internet resource, and wherein the method further comprises controlling access to the internet resource based on the safety level.

23. A computer-program product tangibly embodied in a non-transitory machine-readable storage medium, including instructions configured to cause a data processing apparatus to perform operations including:
determining a key associated with an internet resource;
performing a primary hash on the key to obtain a primary hash result;
performing a set of secondary hashes on the key to obtain one or more secondary hash results, wherein the set of secondary hashes comprises one or more secondary hashes;
identifying a set of buckets of a data structure using the set of secondary hashes, wherein identifying the set of buckets comprises identifying a bucket for each secondary hash of the set of secondary hashes, wherein each bucket of the identified set of buckets contains one or more payloads, and wherein each payload of the one or more payloads comprises value data and hash data;
determining a set of matching payloads from the identified set of buckets using the primary hash result, wherein determining the set of matching payloads comprises identifying a payload from each of the identified set of buckets such that the identified payloads contain matching value data and such that each of the identified payloads includes the primary hash result in the hash data; and
determining value information using the matching value data, wherein the value information is indicative of a category associated with the internet resource.

24. The computer-program product of claim 23, wherein determining value information using the matching value data comprises accessing a value index of the data structure using the matching value data to determine the value information, wherein the matching value data identifies one or more locations within the value index.

25. The computer-program product of claim 24, wherein at least one of the one or more locations within the value index contains location information for a location in the data structure usable to obtain the value information.

26. The computer-program product of claim 23, wherein the matching value data is the value information.

27. The computer-program product of claim 23, wherein the internet resource is a website identifiable by a uniform resource identifier, and wherein determining the key comprises using the uniform resource identifier to determine the key.

28. The computer-program product of claim 27, wherein determining the key comprises:
receiving the uniform resource identifier associated with the website; and
extracting a portion of the uniform resource identifier to use as the key.

29. The computer-program product of claim 28, wherein the operations further comprise:
determining additional value information is available for the uniform resource identifier using the matching value data or the value information;
extracting an additional portion of the uniform resource identifier to use as an additional key, wherein the additional portion of the uniform resource identifier is different from the portion of the uniform resource identifier; and
determining the additional value information using the additional key.

30. The computer-program product of claim 29, wherein determining additional value information is available comprises determining directional information indicative of an upwards direction or a downwards direction in a hierarchy of the uniform resource identifier, and wherein extracting the additional portion of the uniform resource identifier comprises using the directional information.

31. The computer-program product of claim 23, wherein determining the value information comprises:
accessing a special value associated with the matching value data, wherein the special value is indicative that the key contains value information; and
extracting at least some of the value information from the key.

32. The computer-program product of claim 31, wherein the internet resource is a website identifiable by a uniform resource identifier, wherein the key includes a domain element of the uniform resource identifier, and wherein extracting the at least some of the value information from the key comprises using the domain element or a modified version of the domain element as at least a portion of the category.

33. The computer-program product of claim 23, wherein the category is indicative of a safety level associated with the internet resource, and wherein the operations further comprise controlling access to the internet resource based on the safety level.
